(19) United States
(12) Patent Application Publication
(10) Pub. No.: US 2026/0252031 A1
(43) Pub. Date: Aug. 27, 2026

(54) Watch Body, Wearable Device, Waterproof Blocking Module, and Electronic Device

(71) Applicant: HUAWEI TECHNOLOGIES CO., LTD., Shenzhen (CN)

(72) Inventors: Shenglan Yuan, Dongguan (CN); Wenjian Yang, Dongguan (CN); Kemin Zhang, Dongguan (CN); Zhuang Liu, Dongguan (CN)

(73) Assignee: HUAWEI TECHNOLOGIES CO., LTD., Shenzhen (CN)

(21) Appl. No.: 19/648,326

(22) Filed: Apr. 15, 2026

Related U.S. Application Data
(63) Continuation of application No. PCT/CN2024/139987, filed on Dec. 17, 2024.

(30) Foreign Application Priority Data
Apr. 29, 2024 (CN) 202410532708.5

(51) Int. Cl. G04B 37/08

(52) U.S. Cl. CPC G04B 37/08

(57) ABSTRACT

A watch body includes a watch case, a blocking structure disposed on the watch case, and a waterproof breathable member disposed on the watch case. The watch case is provided with a hole communicating with the inside of the watch body, and the blocking structure is disposed on the watch case and is movable along the hole. The waterproof breathable member is located on a side that is of the blocking structure and that faces the inside of the watch body, and the waterproof breathable member communicates with the inside of the watch body. When the blocking structure moves toward the waterproof breathable member along the hole, the blocking structure can block the waterproof breathable member.

### CROSS-REFERENCE TO RELATED APPLICATIONS

This is a continuation of International Patent Application No. PCT/CN2024/139987 filed on December 17, 2024, which claims priority to Chinese Patent Application No. 202410532708.5 filed on April 29, 2024, all of which are hereby incorporated by reference.

### TECHNICAL FIELD

This disclosure relates to the field of wearable device technologies, and in particular, to a wearable device, a watch body that can be used in the wearable device, a waterproof blocking module, and an electronic device including the waterproof blocking module.

### BACKGROUND

A wearable device is generally a micro electronic device that can be worn on a body for activities, and may include a smart watch and a smart band.

The wearable device is used in increasingly complex environments, for example, there is a need to use the wearable device in a deep water environment. In this case, the wearable device needs to have a waterproof function. Some wearable devices have low waterproof levels. For example, the wearable device can be used only in a water environment in which a water depth is less than 100 meters. Therefore, to further improve use performance, a waterproof structure of the wearable device further needs to be optimized, to meet a use requirement in a deeper water area.

### SUMMARY

This disclosure provides a wearable device and a watch body that can be used in the wearable device, and further provides an electronic device and a waterproof blocking module that can be used in the electronic device. An objective is to provide an electronic device that has a waterproof function and that can be used in a deep water area. For example, the electronic device may be a wearable device.

To achieve the foregoing objectives, the following technical solutions are used in embodiments of this disclosure.

According to a first aspect, this disclosure provides a watch body. The watch body may be used in a wearable device. For example, the wearable device may be a watch or a band.

The watch body provided in this disclosure includes a watch case, a blocking structure disposed on the watch case, and a waterproof breathable member disposed on the watch case. The watch case is provided with a hole communicating with the inside of a watch body, and the blocking structure is disposed on the watch case and is movable along the hole. The waterproof breathable member is located on a side that is of the blocking structure and that faces the inside of the watch body, and the waterproof breathable member communicates with the inside of the watch body. When the blocking structure moves toward the waterproof breathable member along the hole, the blocking structure can block the waterproof breathable member.

The blocking structure provided in this disclosure is movable along the hole, that is, the blocking structure movably fits the watch case, and in particular, a hole for the blocking structure to slide communicates with internal space of the watch body. After the wearable device is immersed in water, a pressure difference is formed between external water and the inside of the watch body. For example, as a diving depth increases, water pressure increases. The water pressure of the external water gradually overcomes internal pressure of the watch body, a friction force between the blocking structure and the watch case, and the like. In this way, the blocking structure moves along the hole until the blocking structure is attached to the waterproof breathable member, and blocks the waterproof breathable member.

Therefore, the blocking structure in this embodiment of this disclosure is an automatic mechanical blocking structure, and does not need to be operated by a user. Instead, the blocking structure blocks the waterproof breathable member by using a difference between the external water pressure and the internal pressure of the device.

In addition, after the wearable device is immersed in water, as the diving depth gradually increases, the water pressure gradually increases, and the blocking structure moves continuously along the hole, and gradually approaches the waterproof breathable member. In addition, as the diving depth increases, the water pressure increases, and the blocking structure presses the waterproof breathable member tighter, and a blocking effect is better. For example, the wearable device may be used in a water depth of more than 200 meters.

In an implementation, the watch body further includes an elastic member, and the elastic member is configured to apply an elastic force to the blocking structure to move in a direction away from the waterproof breathable member. The blocking structure is movable away from the waterproof breathable member along the hole, to form a gap between the blocking structure and the waterproof breathable member.

For example, when the blocking structure is not subjected to external pressure, the elastic member is in a natural state (which may be understood as an uncompressed state). When the blocking structure is squeezed by the external water pressure, the blocking structure is in contact with the waterproof breathable member, to implement blocking and prevent water from entering the watch body.

For another example, when the external water pressure gradually decreases or even disappears, under the action of the elastic force of the elastic member, the blocking structure in contact with the waterproof breathable member is movable in the direction away from the waterproof breathable member, and squeezing of the blocking structure on the waterproof breathable member gradually disappears, until a gap is formed between the blocking structure and the waterproof breathable member. In this way, the waterproof breathable member can implement functions of breathability and balance of internal and external pressure of the watch body.

In an implementation, the blocking structure includes a pressure bearing plate, a cap, and at least one sliding rod. The sliding rod is connected to the pressure bearing plate, the sliding rod is disposed in the hole, and the sliding rod is movable along the hole. The cap is elastic, the cap is connected to the pressure bearing plate, the cap is located on a side that is of the pressure bearing plate and that faces the waterproof breathable member, and the cap is configured to block the waterproof breathable member.

In this implementation structure, the pressure bearing plate is configured to sense water pressure, and the sliding rod connected to the pressure bearing plate can slide along the hole under the action of the water pressure, to drive the cap to move toward the waterproof breathable member. In addition, in this example, the cap is elastic, and the elastic cap can better fit the waterproof breathable member, to improve a waterproof effect.

In an implementation, the cap includes a plate-shaped part, and the plate-shaped part is configured to block the waterproof breathable member.

In this example, the cap is of a plate-shaped structure, and the waterproof breathable member is blocked through the plate-shaped cap.

In an implementation, a side that is of the cap and that faces the waterproof breathable member includes a closed ring structure, and the ring structure protrudes in a direction toward the waterproof breathable member. When the cap blocks the waterproof breathable member, the ring structure is disposed around the waterproof breathable member.

In an implementation, a side that is of the cap and that faces the waterproof breathable member includes a closed ring structure, and the ring structure protrudes in a direction toward the waterproof breathable member. The cap further includes a plate-shaped part, the ring structure surrounds the plate-shaped part, and the plate-shaped part and the ring structure are configured to block the waterproof breathable member.

In this example, the cap includes a plate-shaped part and a ring structure. In this way, a size of the entire cap can be increased, and elastic stability of the cap can be improved.

In an implementation, the cap is of a ring structure, and the pressure bearing plate and the ring structure are configured to block the waterproof breathable member.

In this example, the waterproof breathable member is blocked through the ring-shaped cap and the pressure bearing plate.

In an implementation, there are a plurality of sliding rods, , the sliding rods are spaced from each other on the pressure bearing plate, and the cap is disposed around the plurality of sliding rods, or the cap is located between the plurality of sliding rods.

In an example, the cap may be disposed between the sliding rods. In another example, the cap may be disposed on a periphery of the sliding rod.

In an implementation, the waterproof breathable member includes a breathable area and a peripheral area disposed around the breathable area, the breathable area has a plurality of breathable holes, and the breathable holes communicate with the inside of the watch body. The side that is of the cap and that faces the waterproof breathable member includes the closed ring structure, and the ring structure protrudes in the direction toward the waterproof breathable member to form a protrusion. When the cap blocks the waterproof breathable member, the protrusion is attached to the peripheral area.

In this example, when the cap blocks the waterproof breathable member, the protrusion of the cap is attached to the peripheral area of the waterproof breathable member. In this way, the waterproof breathable member can be pressed more tightly, and a waterproof effect is better.

In an implementation, the sliding rod is provided with insert space, the elastic member is located in the insert space, one end of the elastic member may press against the sliding rod, and the other end of the elastic member may press against the watch case.

The elastic member is disposed in the insert space of the sliding rod. For example, when the elastic member is a spring, the spring may have more circles, and elastic stability is better.

In an implementation, a guide post extending into the insert space is disposed on the watch case, and the elastic member is sleeved on the guide post.

The elastic member is disposed on the guide post, so that a deformation direction of the elastic member can be ensured. In this way, the entire blocking structure can move along a straight line.

In an implementation, the watch body further includes a sealing ring, and the sealing ring is sleeved outside the sliding rod. For example, an outer wall surface of the sliding rod may be provided with a mounting slot, and the sealing ring is disposed in the mounting slot.

In an implementation, the elastic member is sleeved outside the sliding rod.

In an implementation, the watch body further includes a sealing ring, the sealing ring is sleeved outside the sliding rod, and the elastic member and the sealing ring are arranged in an extension direction of the sliding rod.

In this example, both the elastic member and the sealing ring are sleeved outside the sliding rod.

In an implementation, a gasket is disposed between the sealing ring and the elastic member, and the sealing ring is closer to the inside of the watch body than the elastic member.

In an implementation, in an extension direction of the hole, the hole includes a first segment and a second segment, an aperture of the first segment is less than an aperture of the second segment, and the elastic member and the sealing ring are disposed on the second segment.

In an implementation, the cap includes a blocking part and a sealing part connected to the blocking part. The blocking part is movable toward the waterproof breathable member along the hole, so that the blocking part blocks the waterproof breathable member. The sealing part is located in a gap between the sliding rod and the hole.

The cap provided in this example not only includes the blocking part, but also includes the sealing part configured to block the gap between the sliding rod and the hole. In this way, a structure can be simplified, and an assembly process can be simplified.

In an implementation, the blocking part and the sealing part are an integrally formed mechanical member, for example, may be made by using an injection molding process.

In an implementation, when the cap includes the blocking part and the sealing part, the sliding rod is provided with insert space, and the elastic member is located in the insert space.

For example, when the elastic member is a spring, a quantity of spring circles may be increased, to improve stability of an elastic force of the spring.

In an implementation, the watch case has a first surface and a second surface that are opposite to each other, and the first surface faces the blocking structure. The first surface is provided with a groove that is recessed toward the second surface, and the waterproof breathable member is disposed in the groove. A communicating hole is provided between a bottom surface of the groove and the second surface, and the waterproof breathable member communicates with the inside of the watch body through the communicating hole.

The mounting manner of the waterproof breathable member provided in this example may be understood as external mounting, that is, a bottom surface of the waterproof breathable member is supported on the watch case. In this way, when the waterproof breathable member is squeezed by the cap, the waterproof breathable member basically does not deform or fall off.

In an implementation, the waterproof breathable member includes a waterproof breathable film, a dust filter, a first support plate, and a second support plate, and the first support plate and the second support plate each are provided with a breathable hole. The waterproof breathable film and the dust filter are stacked between the first support plate and the second support plate.

The waterproof breathable member not only includes the waterproof breathable film, but may also include the dust filter, so that the waterproof breathable member has a dustproof function.

In addition, disposing the support plate can improve rigidity of the waterproof breathable member.

In an implementation, the watch body includes a decorative plate, the decorative plate is provided with a mounting cavity, and at least a part of the blocking structure is slidably disposed in the mounting cavity. The decorative plate is provided with a through hole for communicating with the inside of the watch case.

When the blocking structure does not block the waterproof breathable member, the through hole may be configured to communicate the inside with the outside of the watch body, and the waterproof breathable member may provide functions such as waterproof and breathability applied by the waterproof breathable member.

In an implementation, a filter structure is disposed at the through hole.

According to a second aspect, this disclosure provides a watch body. The watch body may include a watch case, a blocking structure, a waterproof breathable member, and an elastic member. The watch case is provided with a hole communicating with the inside of the watch body. The blocking structure is disposed on the watch case and is movable in an extension direction of the hole. The waterproof breathable member is located on a side that is of the blocking structure and that faces internal space of the watch body. The waterproof breathable member communicates with the internal space of the watch body, and the elastic member is configured to apply an elastic force to the blocking structure to move away from the waterproof breathable member.

In addition, the blocking structure includes a pressure bearing plate, a cap, and at least one sliding rod. The sliding rod is connected to the pressure bearing plate, the sliding rod is disposed in the hole, and the sliding rod is movable along the hole. The cap is elastic, the cap is connected to the pressure bearing plate, and the cap is located on a side that is of the pressure bearing plate and that faces the waterproof breathable member. The blocking structure moves toward the waterproof breathable member along the hole, and the cap can block the waterproof breathable member. The blocking structure moves away from the waterproof breathable member along the hole to form a gap between the blocking structure and the waterproof breathable member.

For example, when the blocking structure is not subjected to external pressure, the elastic member is in a natural state (which may be understood as an uncompressed state). When the blocking structure is squeezed by external water pressure, the blocking structure is in contact with the waterproof breathable member, to implement blocking and prevent water from entering the watch body.

For another example, when external water pressure gradually decreases or even disappears, under the action of the elastic force of the elastic member, the blocking structure in contact with the waterproof breathable member is movable in a direction away from the waterproof breathable member, and squeezing of the blocking structure on the waterproof breathable member gradually disappears, until the gap is formed between the blocking structure and the waterproof breathable member. In this way, the waterproof breathable member can implement functions of breathability and balance of internal and external pressure of the watch body.

In an implementation, there are a plurality of sliding rods, the sliding rods are spaced from each other on the pressure bearing plate, and the cap is located between the plurality of sliding rods.

In an implementation, a side that is of the cap and that faces the waterproof breathable member includes a closed ring structure, and the ring structure protrudes in a direction toward the waterproof breathable member. The cap further includes a plate-shaped part, the ring structure surrounds the plate-shaped part, and the plate-shaped part and the ring structure are configured to block the waterproof breathable member.

In this example, the cap includes a plate-shaped part and a ring structure. In this way, a size of the entire cap can be increased, and elastic stability can be improved.

In an implementation, the waterproof breathable member includes a breathable area and a peripheral area disposed around the breathable area, the breathable area has a plurality of breathable holes, and the breathable holes communicate with the inside of the watch body. A that is of the cap and that faces the waterproof breathable member includes a closed ring structure, and the ring structure protrudes in a direction toward the waterproof breathable member, to form a protrusion. When the cap blocks the waterproof breathable member, the protrusion is attached to the peripheral area.

In this example, when the cap blocks the waterproof breathable member, the protrusion of the cap is attached to the peripheral area of the waterproof breathable member. In this way, the waterproof breathable member can be pressed more tightly, and a waterproof effect is better.

In an implementation, the sliding rod is provided with insert space, the elastic member is located in the insert space, one end of the elastic member may press against the sliding rod, and the other end of the elastic member may press against the watch case.

The elastic member is disposed in the insert space of the sliding rod. For example, when the elastic member is a spring, the spring may have more circles, and elastic stability is better.

In an implementation, a guide post extending into the insert space is disposed on the watch case, and the elastic member is sleeved on the guide post.

The elastic member is disposed on the guide post, so that a deformation direction of the elastic member can be ensured. In this way, the entire blocking structure can move along a straight line.

In an implementation, the watch body further includes a sealing ring, and the sealing ring is sleeved outside the sliding rod. For example, an outer wall surface of the sliding rod may be provided with a mounting slot, and the sealing ring is disposed in the mounting slot.

In an implementation, the watch case has a first surface and a second surface that are opposite to each other, and the first surface faces the blocking structure. The first surface is provided with a groove that is recessed toward the second surface, and the waterproof breathable member is disposed in the groove. A communicating hole is provided between a bottom surface of the groove and the second surface, and the waterproof breathable member communicates with the inside of the watch body through the communicating hole.

The mounting manner of the waterproof breathable member provided in this example may be understood as external mounting, that is, a bottom surface of the waterproof breathable member is supported on the watch case. In this way, when the waterproof breathable member is squeezed by the cap, the waterproof breathable member basically does not deform or fall off.

In an implementation, the waterproof breathable member includes a waterproof breathable film, a dust filter, a first support plate, and a second support plate, and the first support plate and the second support plate each are provided with a breathable hole. The waterproof breathable film and the dust filter are stacked between the first support plate and the second support plate.

The waterproof breathable member not only includes the waterproof breathable film, but may also include the dust filter, so that the waterproof breathable member has a dustproof function.

In addition, disposing the support plate can improve rigidity of the waterproof breathable member.

In an implementation, the watch body includes a decorative plate, the decorative plate is provided with a mounting cavity, and at least a part of the blocking structure is slidably disposed in the mounting cavity. The decorative plate is provided with a through hole for communicating with the inside of the watch case.

When the blocking structure does not block the waterproof breathable member, the through hole may be configured to communicate the inside with the outside of the watch body, and the waterproof breathable member may provide functions such as waterproof and breathability applied by the waterproof breathable member.

In an implementation, a filter structure is disposed at the through hole.

According to a third aspect, this disclosure provides a wearable device. The wearable device includes a watch strap and a watch body. The watch body is the watch body according to any one of the foregoing implementations. The watch strap is connected to the watch body.

Because the wearable device includes any one of the foregoing watch bodies, after the wearable device dives, the blocking structure can block the waterproof breathable member by using a pressure difference between the inside and the outside of the watch body.

The blocking structure in the wearable device in this embodiment of this disclosure is an automatic mechanical blocking structure, and does not need to be operated by a user. Instead, the blocking structure blocks the waterproof breathable member by using a difference between external water pressure and internal pressure of the device.

After the wearable device is immersed in water, as the diving depth gradually increases, the water pressure gradually increases, and the blocking structure moves continuously along the hole, and gradually approaches the waterproof breathable member. In addition, as the diving depth increases, the water pressure increases, and the blocking structure presses the waterproof breathable member tighter, and a blocking effect is better. For example, the wearable device may be used in a water depth of more than 200 meters, to improve use performance of the device.

According to a fourth aspect, this disclosure provides a waterproof blocking module. The waterproof blocking module is configured to be disposed in an electronic device. The waterproof blocking module may include a support member, a blocking structure disposed on the support member, and a waterproof breathable member. The support member is configured to enclose a hole communicating with the inside of a main body of the electronic device. The waterproof breathable member is located on a side that is of the blocking structure and that faces the inside of the main body of the electronic device, and the waterproof breathable member communicates with the inside of the main body of the electronic device. The blocking structure is movable toward the waterproof breathable member along the hole, to block the waterproof breathable member.

The waterproof blocking module provided in this example may be mounted on the main body of the electronic device. For example, the electronic device may be a wearable device, or may be glasses. After the electronic device dives, the blocking structure may block the waterproof breathable member by using a pressure difference between the inside and the outside.

In an implementation, the waterproof blocking module further includes an elastic member, and the elastic member is configured to apply an elastic force to the blocking structure to move in a direction away from the waterproof breathable member. The blocking structure is movable away from the waterproof breathable member along the hole, to form a gap between the blocking structure and the waterproof breathable member.

For example, when the blocking structure is not subjected to external pressure, the elastic member is in a natural state (which may be understood as an uncompressed state). When the blocking structure is squeezed by external water pressure, the blocking structure is in contact with the waterproof breathable member, to implement blocking and prevent water from entering the watch body.

For another example, when the external water pressure gradually decreases or even disappears, under the action of the elastic force of the elastic member, the blocking structure in contact with the waterproof breathable member is movable in the direction away from the waterproof breathable member, and squeezing of the blocking structure on the waterproof breathable member gradually disappears, until a gap is formed between the blocking structure and the waterproof breathable member. In this way, the waterproof breathable member can implement functions of breathability and balance of internal and external pressure of the watch body.

In an implementation, the blocking structure includes a pressure bearing plate, a cap, and at least one sliding rod. The sliding rod is connected to the pressure bearing plate, the sliding rod is disposed in the hole, and the sliding rod is movable along the hole. The cap is elastic, the cap is connected to the pressure bearing plate, the cap is located on a side that is of the pressure bearing plate and that faces the waterproof breathable member, and the cap is configured to block the waterproof breathable member.

In an implementation, the cap includes a plate-shaped part, and the plate-shaped part is configured to block the waterproof breathable member.

In this example, the cap is of a plate-shaped structure, and the waterproof breathable member is blocked through the plate-shaped cap.

In an implementation, a side that is of the cap and that faces the waterproof breathable member includes a closed ring structure, and the ring structure protrudes in a direction toward the waterproof breathable member. When the cap blocks the waterproof breathable member, the ring structure is disposed around the waterproof breathable member.

In an implementation, a side that is of the cap and that faces the waterproof breathable member includes a closed ring structure, and the ring structure protrudes in a direction toward the waterproof breathable member. The cap further includes a plate-shaped part, the ring structure surrounds the plate-shaped part, and the plate-shaped part and the ring structure are configured to block the waterproof breathable member.

In this example, the cap includes a plate-shaped part and a ring structure. In this way, a size of the entire cap can be increased, and elastic stability can be improved.

In an implementation, the cap is of a ring structure, and the pressure bearing plate and the ring structure are configured to block the waterproof breathable member.

In this example, the waterproof breathable member is blocked through the ring-shaped cap and the pressure bearing plate.

In an implementation, there are a plurality of sliding rods, there are a plurality of sliding rods, the sliding rods are spaced from each other on the pressure bearing plate, and the cap is disposed around the plurality of sliding rods, or the cap is located between the plurality of sliding rods.

In an example, the cap may be disposed between the sliding rods. In another example, the cap may be disposed on a periphery of the sliding rod.

In an implementation, the waterproof breathable member includes a breathable area and a peripheral area surrounding a periphery of the breathable area, the breathable area has a plurality of breathable holes, and the breathable holes communicate with the inside of the watch body. A that is of the cap and that faces the waterproof breathable member includes a closed ring structure, and the ring structure protrudes in a direction toward the waterproof breathable member, to form a protrusion. When the cap blocks the waterproof breathable member, the protrusion is attached to the peripheral area.

In this example, when the cap blocks the waterproof breathable member, the protrusion of the cap is attached to the peripheral area of the waterproof breathable member. In this way, the waterproof breathable member can be pressed more tightly, and a waterproof effect is better.

In an implementation, the sliding rod is provided with insert space, the elastic member is located in the insert space, one end of the elastic member may press against the sliding rod, and the other end of the elastic member may press against the watch case.

The elastic member is disposed in the insert space of the sliding rod. For example, when the elastic member is a spring, the spring may have more circles, and elastic stability is better.

In an implementation, a guide post extending into the insert space is disposed on the support member, and the elastic member is sleeved on the guide post.

The elastic member is disposed on the guide post, so that a deformation direction of the elastic member can be ensured. In this way, the entire blocking structure can move along a straight line.

In an implementation, the waterproof blocking module further includes a sealing ring, and the sealing ring is sleeved outside the sliding rod. For example, an outer wall surface of the sliding rod may be provided with a mounting slot, and the sealing ring is disposed in the mounting slot.

In an implementation, the elastic member is sleeved outside the sliding rod.

In an implementation, the waterproof blocking module further includes a sealing ring, the sealing ring is sleeved outside the sliding rod, and the elastic member and the sealing ring are arranged in an extension direction of the sliding rod.

In this example, both the elastic member and the sealing ring are sleeved outside the sliding rod.

In an implementation, the cap includes a blocking part and a sealing part connected to the blocking part. The blocking part is movable toward the waterproof breathable member along the hole, so that the blocking part blocks the waterproof breathable member. The sealing part is located in a gap between the sliding rod and the hole.

The cap provided in this example not only includes the blocking part, but also includes the sealing part configured to block the gap between the sliding rod and the hole. In this way, a structure can be simplified, and an assembly process can be simplified.

In an implementation, the blocking part and the sealing part are an integrally formed mechanical member, for example, may be made by using an injection molding process.

In an implementation, when the cap includes the blocking part and the sealing part, the sliding rod is provided with insert space, and the elastic member is located in the insert space.

For example, when the elastic member is a spring, a quantity of spring circles may be increased, to improve stability of an elastic force of the spring.

In an implementation, the support member has a first surface and a second surface that are opposite to each other, and the first surface faces the blocking structure. The first surface is provided with a groove that is recessed toward the second surface, and the waterproof breathable member is disposed in the groove. A communicating hole is provided between a bottom surface of the groove and the second surface, and the waterproof breathable member communicates with the inside of the main body of the electronic device through the communicating hole.

The mounting manner of the waterproof breathable member provided in this example may be understood as external mounting, that is, a bottom surface of the waterproof breathable member is supported on the watch case. In this way, when the waterproof breathable member is squeezed by the cap, the waterproof breathable member basically does not deform or fall off.

In an implementation, the waterproof breathable member includes a waterproof breathable film, a dust filter, a first support plate, and a second support plate, and the first support plate and the second support plate each are provided with a breathable hole. The waterproof breathable film and the dust filter are stacked between the first support plate and the second support plate.

The waterproof breathable member not only includes the waterproof breathable film, but may also include the dust filter, so that the waterproof breathable member has a dustproof function.

In addition, disposing the support plate can improve rigidity of the waterproof breathable member.

In an implementation, the waterproof blocking module includes a decorative plate, the decorative plate is provided with a mounting cavity, and at least a part of the blocking structure is slidably disposed in the mounting cavity. The decorative plate is provided with a through hole for communicating with the inside of the watch case.

When the blocking structure does not block the waterproof breathable member, the through hole may be configured to communicate the inside with the outside of the watch body, and the waterproof breathable member may provide functions such as waterproof and breathability applied by the waterproof breathable member.

In an implementation, a filter structure is disposed at the through hole.

According to a fifth aspect, this disclosure provides an electronic device. The electronic device includes a main body and the waterproof blocking module according to any one of the foregoing implementations, and further includes a connector. The waterproof blocking module is mounted on a main body through the connector.

In the electronic device provided in this disclosure, the waterproof blocking module may be detachably mounted on the main body, so that the electronic device has a mechanical automatic waterproof function.

In an implementation, the main body includes a watch body of the wearable device.

### BRIEF DESCRIPTION OF DRAWINGS

FIG. 1 is a diagram of a structure of a wearable device according to an embodiment of this disclosure;

FIG. 2 is a diagram of a structure of a watch body of a wearable device according to an embodiment of this disclosure;

FIG. 3 is a diagram of a circuit structure of a wearable device according to an embodiment of this disclosure;

FIG. 4 is a diagram of a partial exploded structure of a watch body of a wearable device according to an embodiment of this disclosure;

FIG. 5 is a diagram of a partial exploded structure of a watch body of a wearable device according to an embodiment of this disclosure;

FIG. 6 is a sectional view of a watch body of a wearable device according to an embodiment of this disclosure;

FIG. 7 is a sectional view of a watch body of a wearable device according to an embodiment of this disclosure;

FIG. 8 is a diagram of a partial exploded structure of a watch body of a wearable device according to an embodiment of this disclosure;

FIG. 9 is an exploded structural diagram of a blocking structure of a wearable device according to an embodiment of this disclosure;

FIG. 10 is a sectional view of a watch body of a wearable device according to an embodiment of this disclosure;

FIG. 11 is a sectional view of a blocking structure of a wearable device according to an embodiment of this disclosure;

FIG. 12 is a sectional view of a sliding rod of a blocking structure of a wearable device according to an embodiment of this disclosure;

FIG. 13 is a sectional view of a sliding rod of a blocking structure of a wearable device according to an embodiment of this disclosure;

FIG. 14 is a sectional view of a watch body of a wearable device according to an embodiment of this disclosure;

FIG. 15 is a sectional view of a waterproof breathable member of a wearable device according to an embodiment of this disclosure;

FIG. 16 is a top view of a waterproof breathable member of a wearable device according to an embodiment of this disclosure;

FIG. 17 is a sectional view of a watch body of a wearable device according to an embodiment of this disclosure;

FIG. 18 is a top view of a waterproof breathable member and a cap of a wearable device according to an embodiment of this disclosure;

FIG. 19 is an exploded structural diagram of a blocking structure of a wearable device according to an embodiment of this disclosure;

FIG. 20 is a sectional view of a watch body of a wearable device according to an embodiment of this disclosure;

FIG. 21 is a sectional view of a watch body of a wearable device according to an embodiment of this disclosure;

FIG. 22 is an exploded structural diagram of a blocking structure of a wearable device according to an embodiment of this disclosure;

FIG. 23 is an exploded structural diagram of a blocking structure of a wearable device according to an embodiment of this disclosure;

FIG. 24 is a sectional view of a watch body of a wearable device according to an embodiment of this disclosure;

FIG. 25 is a sectional view of a waterproof breathable member and a watch case of a wearable device according to an embodiment of this disclosure;

FIG. 26 is a sectional view of a watch body of a wearable device according to an embodiment of this disclosure;

FIG. 27 is a sectional view of a blocking structure of a wearable device according to an embodiment of this disclosure;

FIG. 28 is a sectional view of a watch body of a wearable device according to an embodiment of this disclosure;

FIG. 29 is a sectional view of a blocking structure of a wearable device according to an embodiment of this disclosure;

FIG. 30 is a sectional view of a watch body of a wearable device according to an embodiment of this disclosure;

FIG. 31 is an exploded structural diagram of a blocking structure of a wearable device according to an embodiment of this disclosure;

FIG. 32 is a sectional view of a watch body of a wearable device according to an embodiment of this disclosure;

FIG. 33 is a sectional view of a watch case of a wearable device according to an embodiment of this disclosure;

FIG. 34 is an exploded diagram of a structure of a wearable device according to an embodiment of this disclosure;

FIG. 35 is a sectional view of a watch body of a wearable device according to an embodiment of this disclosure;

FIG. 36 is an exploded diagram of a structure of a wearable device according to an embodiment of this disclosure;

FIG. 37 is a sectional view of a watch body of a wearable device according to an embodiment of this disclosure;

FIG. 38 is a sectional view of a watch body of a wearable device according to an embodiment of this disclosure;

FIG. 39 is an exploded structural diagram of a blocking structure of a wearable device according to an embodiment of this disclosure;

FIG. 40 is a sectional view of a watch body of a wearable device according to an embodiment of this disclosure;

FIG. 41 is an exploded diagram of a structure of a watch case and a waterproof breathable member of a wearable device according to an embodiment of this disclosure;

FIG. 42 is an exploded diagram of a structure of a waterproof breathable member according to an embodiment of this disclosure;

FIG. 43 is an exploded diagram of a structure of a watch body of a wearable device according to an embodiment of this disclosure; and

FIG. 44 is a diagram of a structure of a wearable device according to an embodiment of this disclosure.

### DESCRIPTION OF EMBODIMENTS

Embodiments of this disclosure provide a wearable device. For example, the wearable device may be a smart band or a smart watch. The wearable device may be worn on a wrist, and may implement functions such as time display, timing, time reporting, message notification, motion detection, heart rate monitoring, and blood oxygen level detection.

The wearable device may include a watch strap and a watch body. The watch strap is configured to wrap around a wrist of a user, to implement wearing of the wearable device. The watch body is configured for display.

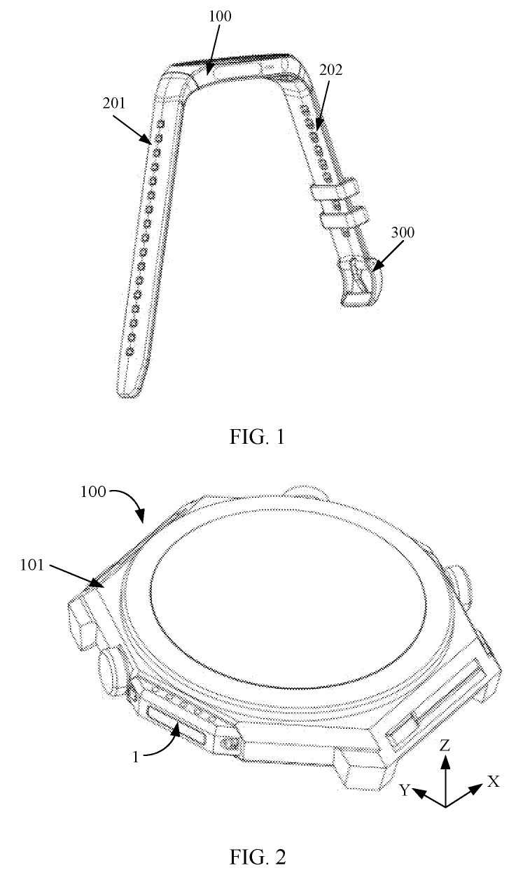

As shown in FIG. 1, FIG. 1 is an example of a diagram of a structure of a wearable device. For example, the wearable device includes a watch body 100, a first watch strap 201, a second watch strap 202, and a connection structure 300. The watch body 100 is connected between the first watch strap 201 and the second watch strap 202. The first watch strap 201 and the second watch strap 202 may be connected through a connection structure 300, so that the first watch strap 201, the watch body 100, and the second watch strap 202 form a closed loop, to wrap around a wrist. The connection structure 300 in this example of this disclosure may be a butterfly buckle or a buckle, or another implementable connection structure. A structure of the connection structure 300 is not specially limited in this disclosure.

In some other wearable devices, one watch strap may be included, and the watch strap is connected to a watch body.

In some examples, the watch strap may be detachably connected to the watch body. Alternatively, the watch strap is fastened to the watch body and is undetachable.

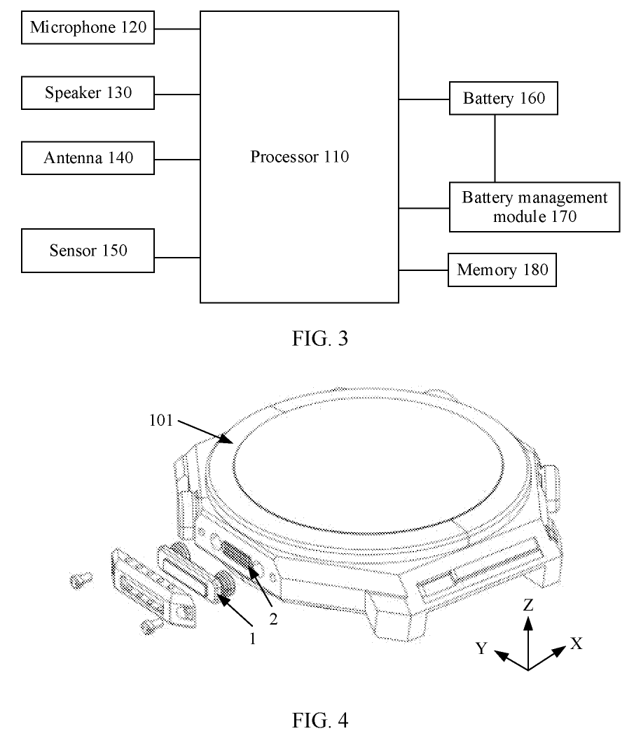

As shown in FIG. 2, FIG. 2 is a diagram of a structure of an appearance of a wearable device according to an example of this disclosure. The wearable device may include a watch case 101, and a plurality of electronic components are disposed in the watch case 101. For example, as shown in FIG. 3, a processor 110, a microphone 120, a speaker 130, an antenna 140, a sensor 150, a battery 160, a battery management module 170, a memory 180, and the like may be disposed in the watch case 101.

The microphone 120, the speaker 130, the antenna 140, the sensor 150, the battery 160, the battery management module 170, and the memory 180 are all electrically connected to the processor 110.

The processor 110 in this example may be a microcontroller unit (MCU), or may be a chip (or an application processor (AP)).

Some wearable devices may include one or more processors. For example, the wearable device may include an MCU, and may not include an AP. For another example, the wearable device may include an MCU and an AP.

In an example, for example, a sound diffused by the speaker 130 needs to be propagated to the outside of the wearable device. In this case, the watch case 101 needs to be provided with a microphone hole. For another example, a pressure difference between the inside and the outside of the wearable device needs to be maintained. In this case, the watch case 101 may be provided with a balance hole. For another example, water inside the wearable device needs to be discharged. In this case, the watch case 101 may be provided with a drainage hole.

To prevent external water from entering the wearable device through these holes in the foregoing examples, and prevent the water from damaging the electronic component inside the watch case, in some implementable structures, waterproof breathable members may be disposed in these holes, and the waterproof breathable members have a waterproof function. Air may also enter the inside of the watch case through a breathable hole on the waterproof breathable member, and air inside the watch case may also flow to the outside of the watch case through the breathable hole on the waterproof breathable member.

In some wearable devices, when a water depth is large (for example, more than 100 meters), the waterproof breathable member may burst due to high water pressure, and the wearable device is damaged.

To meet multi-environment use of a user, for example, use of a wearable device in a deep-water high-pressure environment, embodiments of this disclosure provide some wearable devices having a waterproof function.

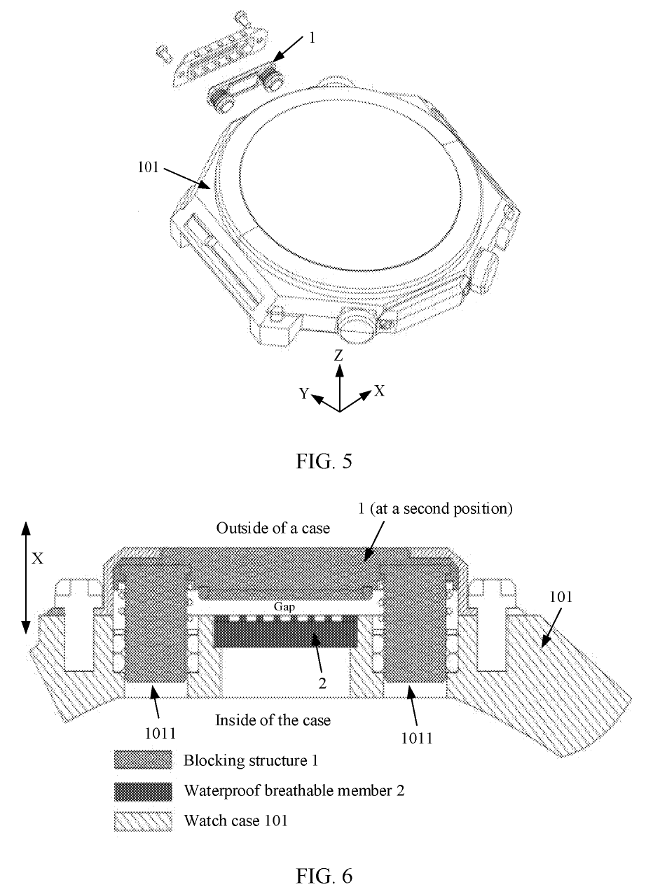

As shown in FIG. 4 and FIG. 5, FIG. 4 is an exploded diagram of a wearable device according to an embodiment of this disclosure, and FIG. 5 is a diagram of FIG. 4 from another perspective. In addition to a watch case 101 and a waterproof breathable member 2, the wearable device may further include a blocking structure 1. The blocking structure 1 may block the waterproof breathable member 2, to prevent external water from entering the watch case 101 through the waterproof breathable member 2.

In the examples in FIG. 4 and FIG. 5, an X-Y plane is a plane perpendicular to a thickness Z direction of the wearable device, that is, it may be understood that a Z direction is parallel to a thickness direction of the wearable device, and the X-Y plane is parallel to a plane on which a watch face is located.

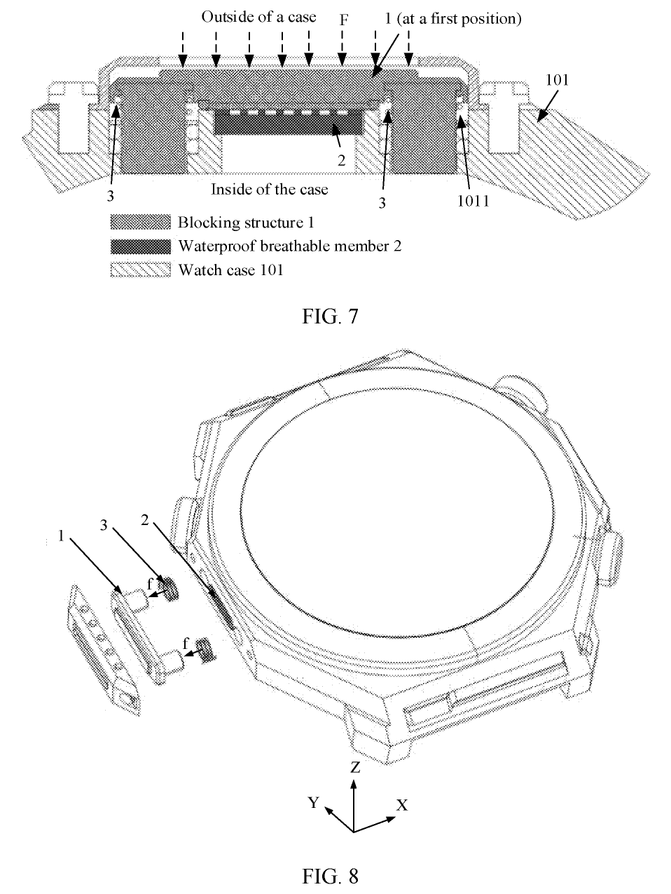

As shown in FIG. 6 and FIG. 7, FIG. 6 and FIG. 7 are respectively sectional views of the wearable device according to this disclosure. FIG. 6 is a structural diagram when the blocking structure 1 does not block the waterproof breathable member 2, and FIG. 7 is a structural diagram when the blocking structure 1 blocks the waterproof breathable member 2.

As shown in FIG. 6 and FIG. 7, the watch case 101 is provided with a hole 1011 communicating with internal space of the watch case 101, and the blocking structure 1 is disposed on the watch case 101 and is movable in an extension direction of the hole 1011. In other words, the blocking structure 1 is slidably connected to the watch case 101 and is movable in an axial direction (the extension direction) of the hole 1011.

The waterproof breathable member 2 is disposed on the watch case 101, the waterproof breathable member 2 is located on a side that is of the blocking structure 1 and that faces the internal space of the watch case 101, and the waterproof breathable member 2 communicates with the internal space of the watch case 101. It may be understood that the waterproof breathable member 2 is closer to the inside of the watch case 101 than the blocking structure 1.

Because the blocking structure 1 is movable along the hole 1011, when the blocking structure 1 moves toward the waterproof breathable member 2 along the hole 1011, the blocking structure 1 can block the waterproof breathable member 2.

In some examples, as shown in FIG. 6 and FIG. 7, the blocking structure 1 and the waterproof breathable member 2 may be arranged in an X direction, and the blocking structure 1 is movable toward the waterproof breathable member 2 in the X direction, to block the waterproof breathable member 2. For example, the extension direction of the hole 1011 is parallel to the X direction. In this way, the blocking structure 1 is movable toward the waterproof breathable member 2 in the X direction.

The blocking structure 1 and the waterproof breathable member 2 cooperate with each other. For a waterproof principle, refer to FIG. 6 and FIG. 7.

After the wearable device dives, for example, in a shallow water area, water pressure is less than internal pressure of the watch case 101, or water pressure is basically equal to internal pressure of the watch case 101. In this case, the blocking structure 1 basically remains stationary. Because of waterproof performance of the waterproof breathable member 2, water may be prevented from entering the wearable device. As a diving depth increases, the water pressure increases. Because the hole for the blocking structure 1 to move communicates with the inside of the watch case 101, there is a pressure difference formed between the water pressure and the internal pressure of the watch case 101, and the water pressure gradually overcomes the internal pressure of the watch case, a friction force between the blocking structure and the watch case, and the like. In this way, as shown in FIG. 7, the blocking structure 1 moves toward the waterproof breathable member 2 along the hole 1011 under the action of the water pressure F. As the water pressure gradually increases, the blocking structure 1 moves continuously along the hole until the blocking structure 1 blocks the waterproof breathable member 2. In this way, water can be prevented from entering the wearable device through the waterproof breathable member 2.

The blocking structure 1 provided in this disclosure is an automatic mechanical blocking apparatus, and uses a difference between external water pressure and internal pressure of the wearable device, so that the blocking structure 1 automatically moves under the action of the pressure difference, to block the waterproof breathable member 2. In a process in which the blocking structure 1 moves toward the waterproof breathable member 2 and blocks the waterproof breathable member 2, no user operation is required. This can improve a safety coefficient after a user enters water and improve experience.

In addition, as the diving depth gradually increases, the water pressure gradually increases, and the blocking structure 1 moves continuously along the hole, and may gradually approach the waterproof breathable member 2. In addition, as the diving depth increases, the water pressure increases, the blocking structure 1 presses the waterproof breathable member 2 tighter, and a blocking effect is better. For example, the wearable device may be used in a deep water area (for example, may be used in a water depth of more than 200 meters), to improve use performance of the wearable device.

As shown in FIG. 6, in a use environment in which the wearable device does not dive, the blocking structure 1 is away from the waterproof breathable member 2, and does not block the waterproof breathable member 2. In this way, the inside of the watch case communicates with the outside, so that sound diffusion, internal and external pressure balance, and the like can be implemented.

When the external water pressure decreases, the blocking structure 1 is movable in a direction away from the waterproof breathable member 2, and return to an initial position.

In an example, the blocking structure 1 may be made of an elastic material, and the blocking structure 1 is away from the waterproof breathable member 2 by using a rebound force of the elastic material.

In another example, as shown in FIG. 7 and FIG. 8, FIG. 8 is an exploded view of a partial structure of the wearable device according to an example of this disclosure. The wearable device may further include an elastic member 3, and the elastic member 3 is configured to provide an elastic force f for the blocking structure 1 to move in the direction away from the waterproof breathable member 2.

In the example in FIG. 8, the wearable device includes the elastic member 3, and the blocking structure 1 may be made of a rigid material, for example, may be made of metal. The elastic force of the elastic member 3 enables the rigid blocking structure 1 to move in the direction away from the waterproof breathable member 2. The rigid blocking structure 1 can improve mechanical strength and improve mobility stability.

In still another example, the blocking structure 1 may be made of an elastic material, and the wearable device may further include an elastic member 3. The elastic member 3 fits the elastic blocking structure 1, so that the blocking structure 1 moves in the direction away from the waterproof breathable member 2. As shown in FIG. 7, when the external water pressure gradually increases, the elastic member 3 deforms under large external water pressure F, and accumulates a rebound force, and the rebound force is in the direction away from the waterproof breathable member 2. When the external water pressure gradually decreases, the blocking structure 1 moves in the direction away from the waterproof breathable member 2 under the action of the rebound force of the elastic member 3, until the blocking structure 1 moves to a state shown in FIG. 6, so that there is a spacing between the blocking structure 1 and the waterproof breathable member 2.

It may be understood that, in this example of this disclosure, as shown in FIG. 6 and FIG. 7, the blocking structure 1 is movable between a first position and a second position in an extension direction (for example, an X direction) of the hole 1011, and the first position is closer to the waterproof breathable member 2 than the second position.

Refer to FIG. 7. When the blocking structure 1 moves to the first position, the blocking structure 1 blocks the waterproof breathable member 2, to prevent external water from entering the inside of the watch case 101 through the waterproof breathable member 2.

Refer to FIG. 6. When the blocking structure 1 moves to the second position, there is a gap between a surface that is of the blocking structure 1 and that faces the waterproof breathable member 2 and the waterproof breathable member 2, so that the inside of the watch case communicates with the outside through the waterproof breathable member 2, to implement breathability. In addition, the waterproof breathable member 2 may also implement waterproof performance, for example, in shallow water (for example, less than 100 meters).

The elastic member 3 is configured to provide an elastic force for the blocking structure 1 to move from the first position to the second position (from FIG. 7 to FIG. 6). When the blocking structure 1 moves from the first position to the second position, the blocking structure 1 moves in the direction away from the waterproof breathable member 2.

In this example of this disclosure, a direction from the first position to the second position may be perpendicular to a surface of the waterproof breathable member 2. For example, the direction from the first position to the second position may be parallel to the X direction.

The blocking structure 1 provided in this disclosure has a plurality of implementable structures.

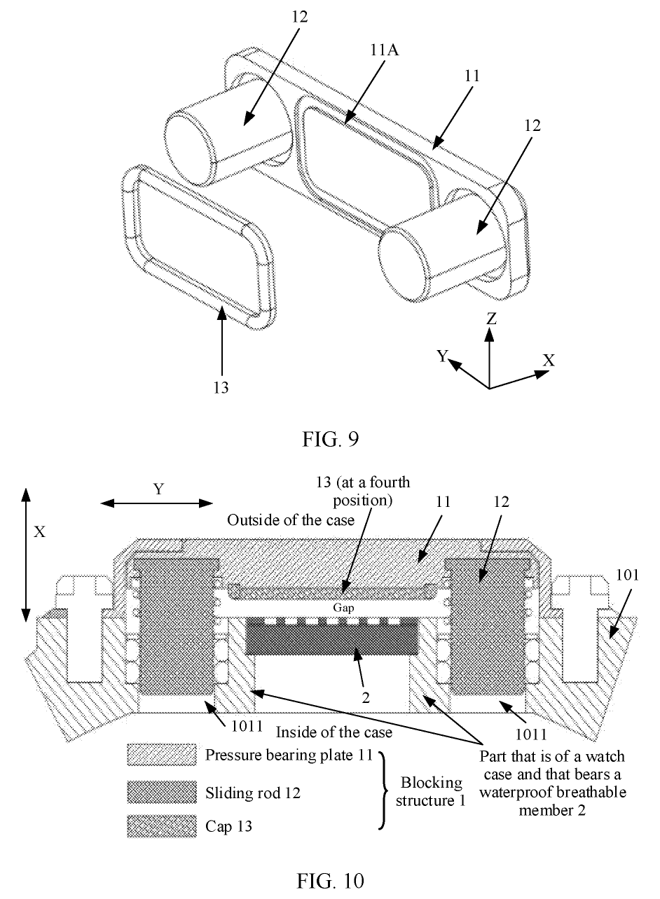

For example, FIG. 9 and FIG. 10 show an implementable example. FIG. 10 is a diagram of a structured in which the example shown in FIG. 9 is mounted in the wearable device. In this example, the blocking structure 1 includes a pressure bearing plate 11, and the pressure bearing plate 11 may be configured to contact external water and sense the external water pressure. The blocking structure 1 further includes at least one sliding rod 12, each sliding rod 12 is connected to the pressure bearing plate 11, and the sliding rod 12 is located on a side that is of the pressure bearing plate 11 and that faces the inside of the watch case.

In some examples, a plurality of sliding rods 12 may be included. For example, the plurality of sliding rods 12 may be located on a side surface of the waterproof breathable member 2. In the example shown in FIG. 9, two sliding rods 12 are included, and the two sliding rods 12 are located on two sides of the waterproof breathable member 2.

The sliding rod 12 is disposed in the hole 1011, and the sliding rod 12 slidably fits the hole 1011. The hole 1011 not only can communicate the inside of the watch case 101 with the outside, but also can guide the sliding rod 12 to move. For example, the sliding rod 12 moves in the hole 1011 in the X direction, so that the sliding rod 12 has higher straight-line motion precision.

In the example in FIG. 9, for example, two sliding rods 12 are included, and the two sliding rods 12 are connected to a same side of the pressure bearing plate 11. As shown in FIG. 10, each sliding rod 12 corresponds to one hole 1011. In this way, the pressure bearing plate 11 and the sliding rod 12 that are connected together can slide in the extension direction of the hole 1011 under an acting force.

In some examples, a plurality of sliding rods 12 are included, and the plurality of sliding rods 12 slide along corresponding holes 1011. The external water pressure acts on the pressure bearing plate 11. The plurality of sliding rods 12 sliding along the holes may make movement of the entire blocking structure 1 more stable, and balance movement of the blocking structure.

In some examples, the pressure bearing plate 11 and the sliding rod 12 may be an integrally formed mechanical member, for example, may be manufactured by using an injection molding process. Alternatively, the pressure bearing plate 11 and the sliding rod 12 are two independent mechanical members, and are connected to each other through a connection structure, for example, the pressure bearing plate and the sliding rod may be connected to each other through a bolt or an adhesive.

The pressure bearing plate 11 and the sliding rod 12 may be made of rigid materials. Materials of the pressure bearing plate 11 and the sliding rod 12 may be the same or different.

For example, the pressure bearing plate 11 and the sliding rod 12 may be metal members.

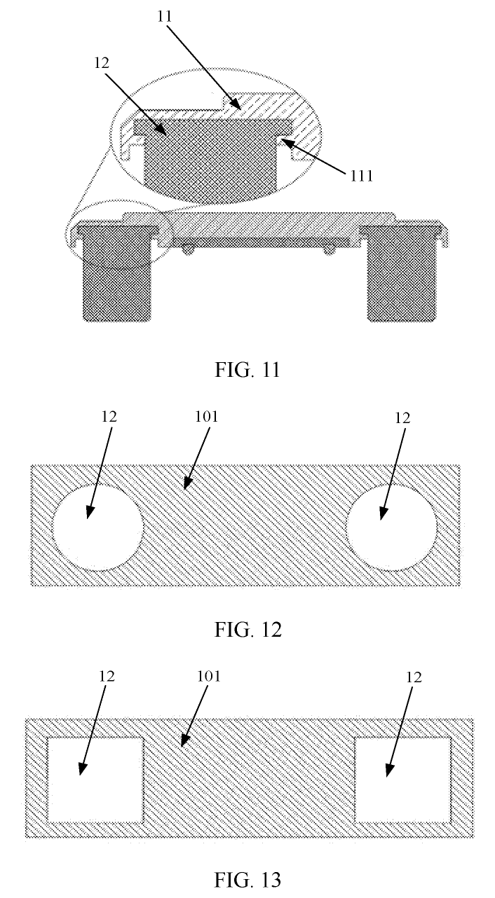

In the example in FIG. 11, to increase connection strength between the pressure bearing plate 11 and the sliding rod 12, and improve stability of synchronous movement of the pressure bearing plate 11 and the sliding rod 12, the sliding rod 12 may be embedded in the pressure bearing plate 11, and a boss 111 may be disposed. The boss 111 may perform a limiting function, to prevent the sliding rod 12 from detaching from the pressure bearing plate 11.

Based on pressure = pressure strength * area, a larger area of a cross section of the sliding rod 12 indicates smaller water pressure. In this way, the blocking structure 1 can be pushed when the wearable device is in a shallow water area, so that the waterproof breathable member 2 can be blocked. For example, when the area of the cross section of the sliding rod 12 is large, for example, when a water depth is greater than or equal to 50 meters, the water pressure can overcome the internal pressure of the watch case, the friction force between the blocking structure and the watch case, the rebound force of the elastic member, and the like, so that the blocking structure 1 gradually moves toward the waterproof breathable member 2.

In this example of this disclosure, the area of the cross section of the sliding rod 12 may be understood as that a surface perpendicular to an extension direction of the sliding rod 12 is the cross section of the sliding rod. For example, the sliding rod 12 extends in the X direction, and the cross section of the sliding rod 12 may be understood as an area of a Y-Z plane perpendicular to the X direction.

FIG. 12 and FIG. 13 show two sliding rods 12 of different structures. In FIG. 12, a cross section of the sliding rod 12 may be a circle, and a cross section of the hole 1011 for the sliding rod 12 to slide may be a circle. In FIG. 13, a cross section of the sliding rod 12 may be a rectangle, and a cross section of the hole 1011 for the sliding rod 12 to slide may be a rectangle. In another example, the cross section of the sliding rod 12 may be in another shape. A shape of the cross section of the sliding rod 12 is not specially limited in this disclosure.

For example, the cross section of the sliding rod 12 is a circle or a rectangle, and the cross section of the hole 1011 is a circle or a rectangle. This can simplify a processing process of the sliding rod 12 and a processing process of the hole, and can also facilitate assembly of another mechanical member, for example, the elastic member mentioned above, or the sealing ring and the gasket mentioned below.

In some examples, when a plurality of sliding rods 12 are included, a spacing between the sliding rods 12 may be compressed as much as possible, to increase the area of the cross section of the sliding rod 12. For example, in FIG. 10, each sliding rod 12 extends in the X direction, and two sliding rods 12 are arranged in a Y direction, so that a size of a part of the watch case that bears the waterproof breathable member 2 in the Y direction can be reduced, and larger space can be reserved for the sliding rod 12, to increase the area of the cross section of the sliding rod 12.

As shown in FIG. 9 and FIG. 10, in some examples, the blocking structure 1 may further include a cap 13. The cap 13 is connected to the pressure bearing plate 11, and the cap 13 is located on a side that is of the pressure bearing plate 11 and that faces the waterproof breathable member 2. For example, when the blocking structure 1 blocks the waterproof breathable member 2, the waterproof breathable member 2 may be blocked through the cap 13 in the blocking structure 1.

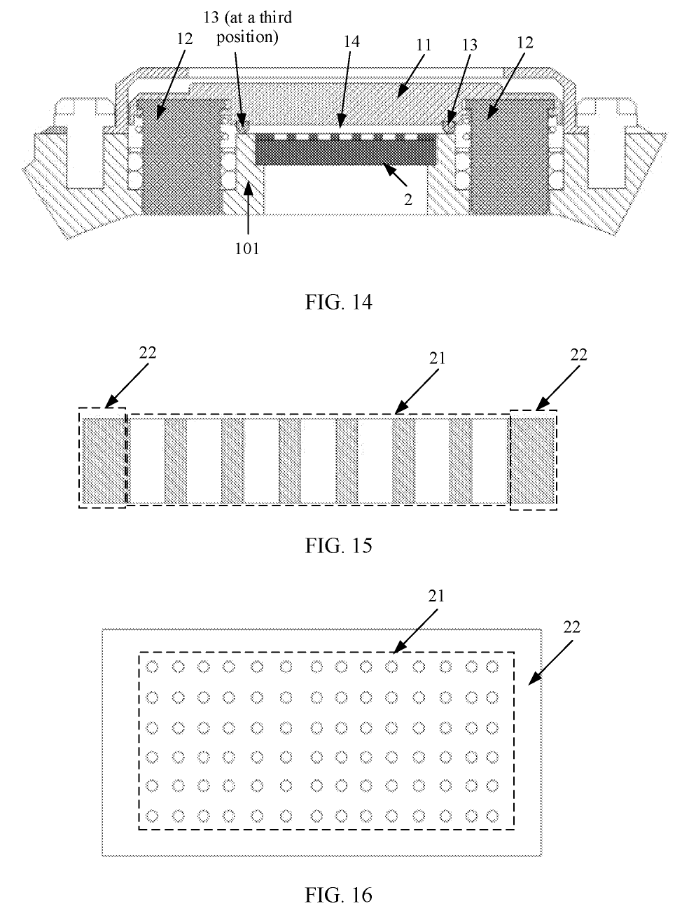

For example, as shown in FIG. 14, FIG. 14 is a diagram of an assembly structure of the cap 13 of a ring structure, the pressure bearing plate 11, and the waterproof breathable member 2. When the blocking structure 1 is located at the first position and blocks the waterproof breathable member 2, the cap 13 is located at a third position, and the cap 13 blocks the waterproof breathable member 2.

For another example, as shown in FIG. 10, when the blocking structure 1 is located at the second position and does not block the waterproof breathable member 2, the cap 13 is located at a fourth position, the cap 13 is away from the waterproof breathable member 2, and there is a gap between the cap 13 and the waterproof breathable member 2.

The third position is closer to the waterproof breathable member 2 than the fourth position.

In this example of this disclosure, a direction from the third position to the fourth position may be parallel to the X direction, and may be parallel to the direction from the first position to the second position.

In some optional materials, the cap 13 may be made of an elastic material, for example, may be made of a rubber material to form a rubber block. Elasticity of the rubber block can improve attachment strength between the cap 13 and the waterproof breathable member 2, and further improve a waterproof effect.

The pressure bearing plate 11, the sliding rod 12, and the cap 13 may be an integrally formed mechanical member.

Alternatively, the pressure bearing plate 11 and the cap 13 may be two independent mechanical members. As shown in FIG. 9, the pressure bearing plate 11 may be provided with a mounting slot 11A, and the cap 13 is disposed in the mounting slot 11A through an adhesive layer.

The cap 13 has a plurality of implementable structures. The following shows several implementable structures as examples.

FIG. 9 and FIG. 10 show a structure of the cap 13. The cap 13 is of a ring structure. For example, the cap 13 may be a ring-shaped rubber ring.

As shown in FIG. 14, in this example, when the cap 13 is at the third position and the waterproof breathable member 2 is blocked, the cap 13 of a ring structure is press-fitted to a periphery of the waterproof breathable member 2, and the waterproof breathable member 2, the pressure bearing plate 11, and the cap 13 of a ring structure enclose a sealing cavity 14, to prevent external water from entering the waterproof breathable member 2.

In a structure, the waterproof breathable member 2 is disposed on the watch case 101. As shown in FIG. 14, when the cap 13 blocks the waterproof breathable member 2, the cap 13 of a ring structure is press-fitted to the watch case 101 on the periphery of the waterproof breathable member 2. That is, in this example, under the action of the external water pressure, the blocking structure 1 moves toward the waterproof breathable member 2 until the blocking structure 1 is attached to the watch case 101 on the periphery of the waterproof breathable member 2.

In another structure, as shown in FIG. 15 and FIG. 16, FIG. 15 is a sectional view of the waterproof breathable member, and FIG. 16 is a top view of the waterproof breathable member. The waterproof breathable member 2 includes a breathable area 21 and a peripheral area 22 located on a periphery of the breathable area 21. The breathable area 21 has a plurality of breathable holes, and the plurality of breathable holes communicate with internal space of the watch case.

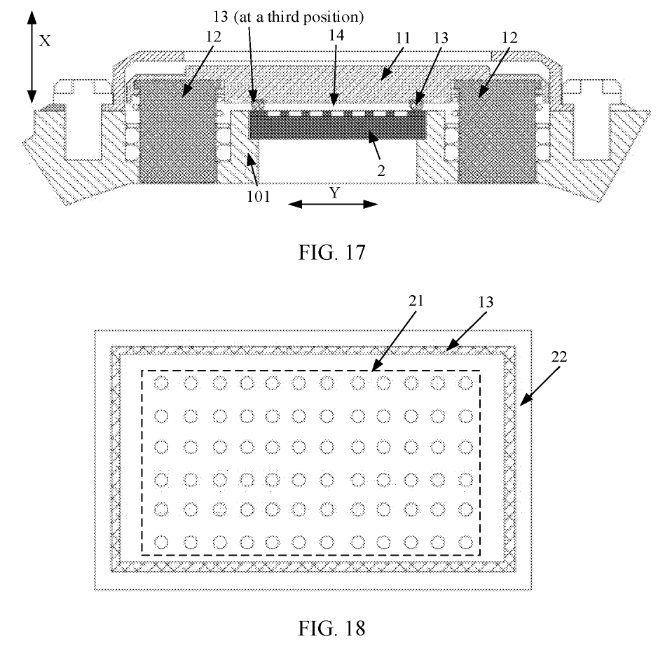

As shown in FIG. 17 and FIG. 18, when the cap 13 is located at the third position and blocks the waterproof breathable member 2, the cap 13 of a ring structure is press-fitted to the peripheral area 22 of the waterproof breathable member 2. It may be understood that, in this example, under the action of the external water pressure, the blocking structure 1 moves toward the waterproof breathable member 2 until the blocking structure 1 is attached to the peripheral area 22 of the waterproof breathable member 2, so that the breathable area 21 of the waterproof breathable member 2 is enclosed in the sealing cavity 14.

Using the example in FIG. 17 can reduce a size of the watch case 101 for bearing the waterproof breathable member 2 in the Y direction. In this way, an area of a cross section of the sliding rod 12 in the examples in FIG. 12 and FIG. 13 can be increased, and a waterproof level of the wearable device can be optimized.

In the example in FIG. 17, the watch case 101 may be provided with a groove, and the waterproof breathable member 2 is disposed in the groove. A surface that is of the waterproof breathable member 2 and that faces the cap 13 is basically flush with an opening of the groove.

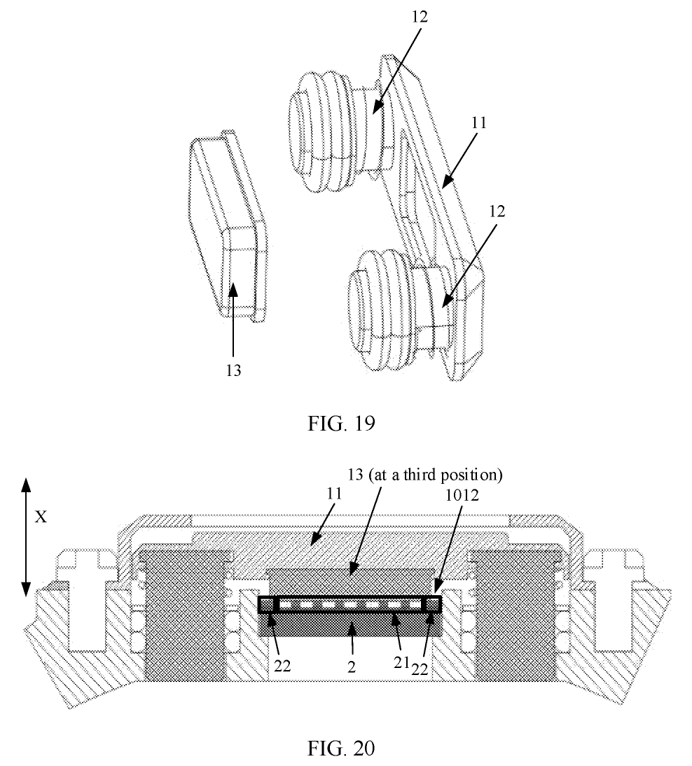

As shown in FIG. 19, FIG. 19 shows still another structure of the cap. The cap 13 is of a plate-shaped structure. For example, the cap may be a rubber sheet.

As shown in FIG. 20, FIG. 20 is a diagram of an assembly structure of the cap 13 of a plate-shaped structure and the waterproof breathable member 2. In this example, when the waterproof breathable member 2 is blocked, the cap 13 of a plate-shaped structure is press-fitted to the waterproof breathable member 2. That is, it may be understood that the plate-shaped cap 13 directly contacts the waterproof breathable member 2.

For example, as shown in FIG. 20, when the blocking structure 1 is located at the first position and blocks the waterproof breathable member 2, the cap 13 is at the third position, and the cap 13 of a plate-shaped structure blocks the waterproof breathable member 2.

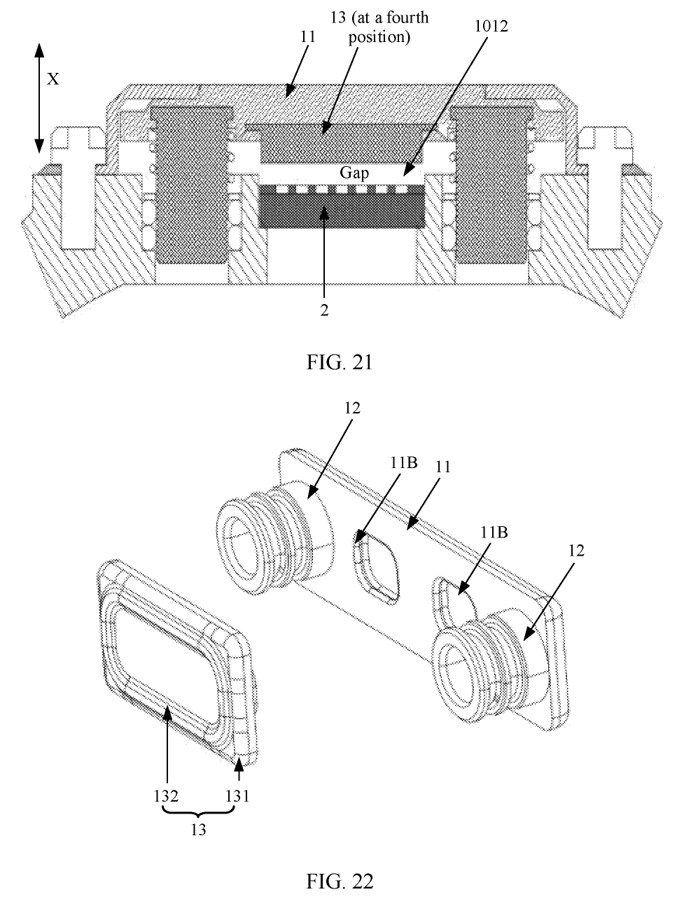

For another example, as shown in FIG. 21, when the blocking structure 1 is located at the second position and does not block the waterproof breathable member 2, the cap 13 is at the fourth position, the plate-shaped cap 13 is away from the waterproof breathable member 2, and there is a gap between the plate-shaped cap 13 and the waterproof breathable member 2.

To improve a waterproof effect, a contour of an orthographic projection of the cap on the waterproof breathable member 2 may be located outside a contour of the waterproof breathable member. In this case, when the cap blocks the waterproof breathable member, an edge of the cap is attached to the watch case.

Alternatively, as shown in FIG. 20, the contour of the orthographic projection of the cap 13 on the waterproof breathable member 2 may be located outside a contour of the breathable area 21 of the waterproof breathable member 2. In this way, when the cap 13 blocks the waterproof breathable member 2, the edge of the cap 13 is attached to the peripheral area 22 of the waterproof breathable member 2.

In the examples of FIG. 20 and FIG. 21, the watch case 101 is provided with a groove 1012, the groove 1012 may be recessed toward the inside of the watch case in the X direction, and the waterproof breathable member 2 is disposed in the groove 1012. The surface that is of the waterproof breathable member 2 and that faces the cap 13 is recessed in an opening of the groove 1012. That is, there is a spacing between the surface that is of the waterproof breathable member 2 and that faces the cap 13 and the opening of the groove 1012. In this way, when the cap 13 needs to block the waterproof breathable member 2, the cap 13 may be inserted into the groove 1012 and press-fitted to the waterproof breathable member 2.

In the example in FIG. 20, when the blocking structure 1 is located at the first position, and the cap 13 is located at the third position to block the waterproof breathable member 2, at least a part of the cap 13 moves to the groove 1012 to block the waterproof breathable member 2.

For another example, as shown in FIG. 21, when the blocking structure 1 is located at the second position, and the cap 13 is located at the fourth position and does not block the waterproof breathable member 2, the cap 13 is located outside the groove 1012, and there is a gap between the cap 13 and the waterproof breathable member 2. Alternatively, a part of the cap 13 is located in the groove 1012, but there is a gap between the cap 13 and the waterproof breathable member 2.

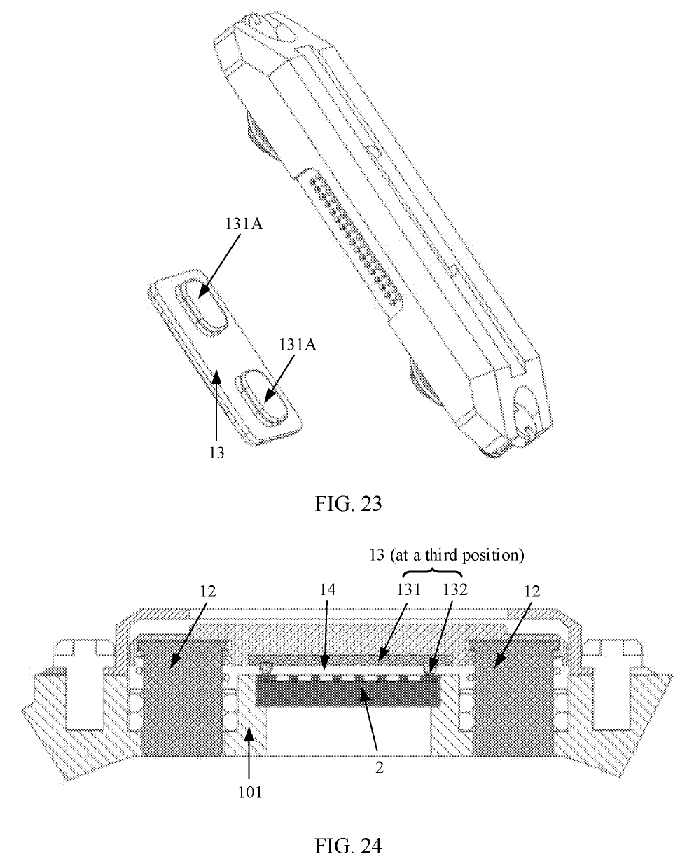

As shown in FIG. 22 and FIG. 23, FIG. 22 and FIG. 23 show another structure of the cap. The cap 13 includes a plate-shaped part 131. A surface that is of the plate-shaped part 131 and that faces the waterproof breathable member 2 has a protrusion 132. The protrusion 132 is disposed around a circumferential direction of the plate-shaped part 131, to form a ring-shaped press-fitting ring. For example, the protrusion 132 may protrude toward the waterproof breathable member 2 in the X direction.

In this example, the cap 13 not only includes the plate-shaped part 131, but may further include the protrusion 132 of a ring structure. In this way, the cap 13 may have a large size and better elasticity, to improve use reliability of the cap.

To increase connection strength between the cap 13 and the pressure bearing plate 11, as shown in FIG. 23, at least two protrusions 131A may be disposed on the plate-shaped part 131. As shown in FIG. 22, the pressure bearing plate 11 is provided with an insert slot 11B for inserting the protrusion 131A. A plurality of protrusions 131A and a plurality of insert slots 11B are connected, to improve the connection strength between the cap 13 and the pressure bearing plate 11, and improve motion stability of the blocking structure 1.

As shown in FIG. 24, FIG. 24 is a diagram of an assembly structure of the cap 13, the pressure bearing plate 11, and the waterproof breathable member 2. In this example, when the waterproof breathable member 2 is blocked, the protrusion 132 that forms the ring-shaped press-fitting ring is press-fitted to the periphery of the waterproof breathable member 2. The waterproof breathable member 2, the plate-shaped part 131, and the ring-shaped press-fitting ring enclose the sealing cavity 14, to prevent external water from entering the waterproof breathable member 2.

In the example in FIG. 24, when the blocking structure 1 is located at the first position, and the cap 13 is located at the third position and blocks the waterproof breathable member 2, the protrusion 132 that forms the ring-shaped press-fitting ring is press-fitted to the periphery of the waterproof breathable member 2.

For another example, when the blocking structure 1 is located at the second position, and the cap 13 is located at the fourth position and does not block the waterproof breathable member 2, the protrusion 132 that forms the ring-shaped press-fitting ring is away from the waterproof breathable member 2, and there is a gap between the protrusion 132 and the waterproof breathable member 2.

In an example, as shown in FIG. 24, when the cap 13 is at the third position, the protrusion 132 that forms the ring-shaped press-fitting ring may be press-fitted to the peripheral area of the waterproof breathable member 2. Alternatively, in some other examples, when the cap 13 is at the third position, the protrusion 132 that forms the ring-shaped press-fitting ring may be press-fitted to the watch case 101 on the periphery of the waterproof breathable member 2.

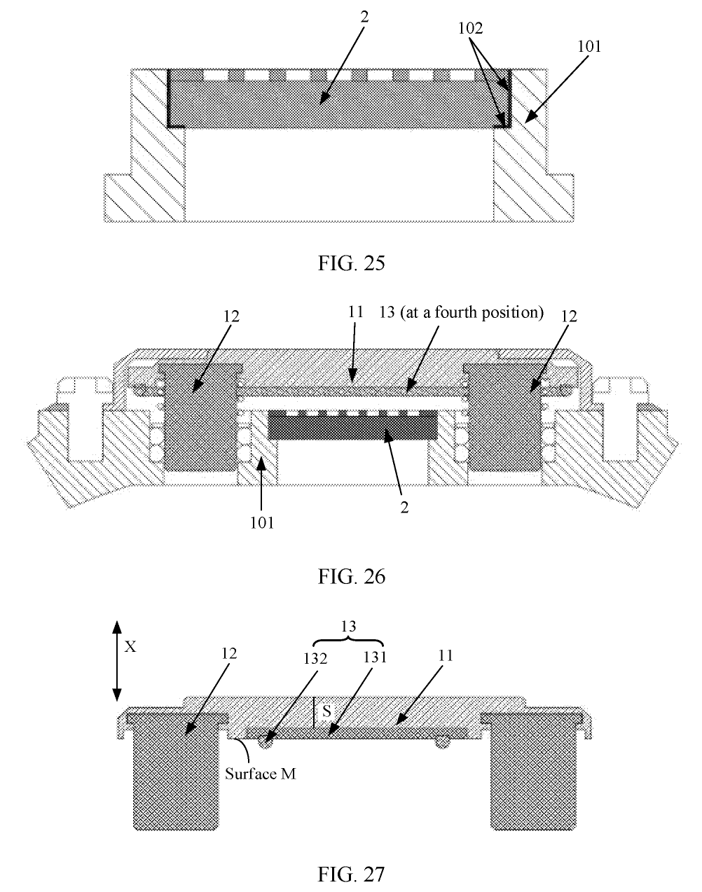

As shown in FIG. 25, the waterproof breathable member 2 is disposed on the watch case 101. For example, the watch case 101 may be provided with a groove, and the waterproof breathable member 2 is disposed in the groove. To prevent a contact position between the waterproof breathable member 2 and the watch case 101 from becoming a water leakage channel, as shown in FIG. 25, a bonding layer 102 may be formed on a contact surface between the waterproof breathable member 2 and the watch case 101, and the bonding layer 102 is configured to fill a gap, to further improve waterproof performance of the device.

In the foregoing examples, a plurality of blocking structures of different structures are listed as an example. For example, the cap of the blocking structure may be of the ring structure shown in FIG. 9 and FIG. 10, or may be of the plate-shaped structure shown in FIG. 19, or may be of the plate-shaped structure and the ring structure shown in FIG. 22. In addition, the foregoing examples further show a plurality of disposing manners of the waterproof breathable member 2. For example, as shown in FIG. 21, the waterproof breathable member 2 is disposed in the groove 1012, or the surface that is of the waterproof breathable member 2 and that faces the cap 13 is flush with the opening of the groove. The foregoing further shows sliding rods 12 of different structures, for example, a sliding rod whose cross sections is a circle or a rectangle.

The blocking structures with different structures may be combined with waterproof breathable members 2 disposed in different manners and sliding rods 12 of different structures, to form wearable devices of different structures. For example, in FIG. 24, the waterproof breathable member 2 may be disposed in the groove 1012 shown in FIG. 21. For another example, in FIG. 24, the cross section of the sliding rod 12 may be a circle, or may be a rectangle. For another example, the cap 13 may be of a plate-shaped structure, or may be of a ring structure.

There are a plurality of cases of a disposing position of the cap on the pressure bearing plate. The following shows several implementable structures.

As shown in FIG. 24, FIG. 24 is a disposing manner of the cap according to an example of this disclosure. There are a plurality of sliding rods 12 connected to the pressure bearing plate 11, the plurality of sliding rods 12 are spaced from each other on the pressure bearing plate 11, and the cap 13 is disposed between the plurality of sliding rods 12. Alternatively, it may be understood that the cap 13 is disposed in an area enclosed by the plurality of sliding rods 12.

For example, the cap 13 is of a plate-shaped structure, and the plurality of sliding rods 12 are spaced from each other along a periphery of the cap of a plate-shaped structure.

For another example, the cap 13 is of a ring structure, and the plurality of sliding rods are spaced from each other along a periphery of the cap of a ring structure.

For another example, as shown in FIG. 24, the cap 13 not only includes a plate-shaped structure part, but also includes a ring structure part, the plurality of sliding rods are arranged around a periphery of the cap, and the plurality of sliding rods are spaced from each other.

As shown FIG. 26, FIG. 26 shows another disposing manner of the cap according to an example of this disclosure. In this example, there are a plurality of sliding rods 12 connected to the pressure bearing plate 11, the plurality of sliding rods 12 are spaced from each other on the pressure bearing plate 11, the cap 13 is of a ring structure, and the cap 13 of a ring structure surrounds a periphery of an area enclosed by the plurality of sliding rods 12.

In the example in FIG. 26, because the cap 13 of a ring structure surrounds the area enclosed by the plurality of sliding rods 12, an area of the waterproof breathable member 2 may be increased, and interference between the cap 13 and the waterproof breathable member 2 may be avoided. Alternatively, in some examples, another mechanical member may be further disposed in the area enclosed by the plurality of sliding rods 12, so that interference between the cap and the another mechanical member can also be avoided.

In the example in FIG. 26, when the cap 13 is at the fourth position and does not block the waterproof breathable member 2, the cap 13 of a ring structure is away from the waterproof breathable member 2, and there is a gap between the cap 13 and the waterproof breathable member 2.

For another example, when the cap 13 is at the third position and blocks the waterproof breathable member 2, the cap 13 of a ring structure is press-fitted to the watch case.

It may be understood that, when the cap 13 blocks the waterproof breathable member 2, the cap 13 may press against the watch case 101 on the periphery of the sliding rod 12. In this way, both the sliding rod 12 and the waterproof breathable member 2 may be sealed in space enclosed by the ring-shaped cap 13, so that not only the waterproof breathable member 2 is blocked, but also a gap between the sliding rod 12 and the hole 1011 is blocked, to further improve a waterproof effect.

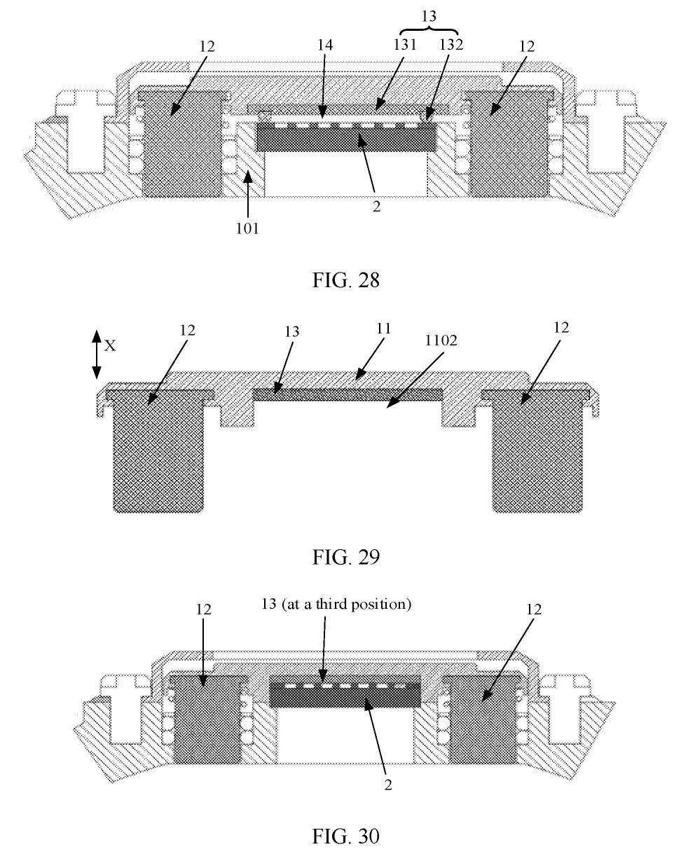

In some examples, as shown in FIG. 27 and FIG. 28, a surface that is of the cap 13 and that faces the waterproof breathable member 2 may protrude from the pressure bearing plate 11. That is, in the X direction, the surface that is of the cap 13 and that faces the waterproof breathable member 2 may protrude from the pressure bearing plate 11. For example, in FIG. 27, when the cap 13 includes the protrusion 132 that forms the ring-shaped press-fitting ring, the protrusion 132 protrudes from a surface M of the pressure bearing plate 11. In this way, a thickness size S of the pressure bearing plate 11 can be ensured, so that the pressure bearing plate 11 has sufficient strength, and basically does not deform under high water pressure.

In some other examples, as shown in FIG. 29, the pressure bearing plate 11 may be provided with a mounting slot 1102, and the cap 13 is disposed in the mounting slot 1102. As shown in FIG. 30, when the cap 13 blocks the waterproof breathable member 2, the waterproof breathable member 2 is located in the mounting slot 1102.

As shown in FIG. 29 and FIG. 30, in the X direction, the mounting slot 1102 is recessed in a direction toward the outside of the watch case.

For example, as shown in FIG. 30, when the cap 13 is at the third position and blocks the waterproof breathable member 2, the waterproof breathable member 2 extends into the mounting slot 1102, and the cap 13 is press-fitted to the waterproof breathable member 2.

For another example, when the cap 13 is at the fourth position and does not block the waterproof breathable member 2, the waterproof breathable member 2 is located outside the mounting slot 1102.

In some wearable devices, as shown in FIG. 29 and FIG. 30, the cap 13 may be of a plate-shaped structure, or the cap 13 may be of a ring structure, or the cap 13 not only includes a plate-shaped structure part, but also includes a ring structure part.

In the wearable device provided in embodiments of this disclosure, the sliding rod 12 is slidably disposed in the hole 1011, there is a gap between the sliding rod 12 and an inner wall surface of the hole 1011, and the hole 1011 communicates with the internal space of the watch case 101. To prevent external water from entering the watch case 101 through the gap between the sliding rod 12 and the hole 1011, the wearable device may further include a sealing ring. The sealing ring may be sleeved outside the sliding rod 12, that is, the sealing ring is located in the gap between the sliding rod and the hole, and the sealing ring is configured to prevent external water from entering the watch case.

The elastic member and the sealing ring provided in this disclosure are disposed in a plurality of manners, as shown in the following examples.

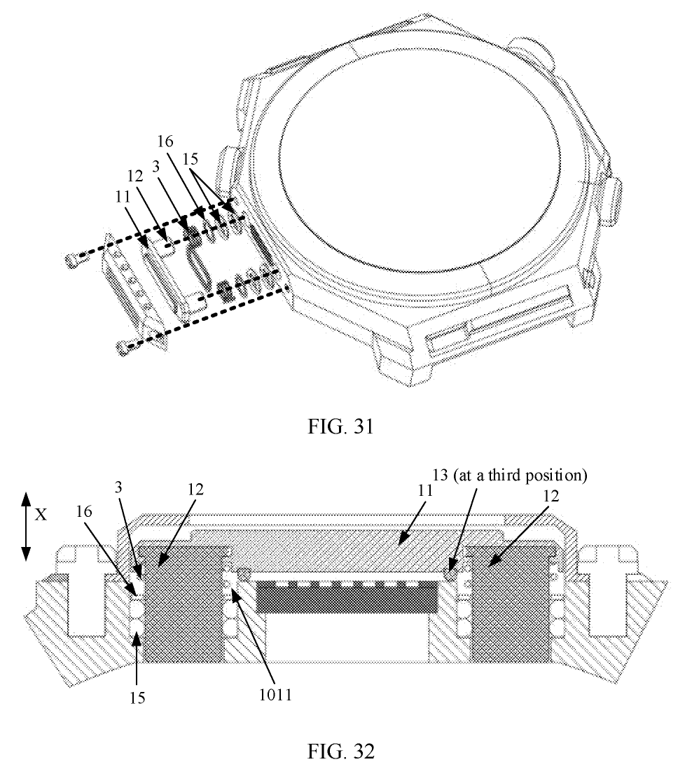

Refer to FIG. 31 and FIG. 32. FIG. 31 and FIG. 32 show an example of a disposing manner of the elastic member and the sealing ring. In this example, the elastic member 3 may be sleeved outside the sliding rod 12.

In this example, the sealing ring 15 is sleeved outside the sliding rod 12, and the sealing ring 15 and the elastic member 3 may be arranged in the extension direction of the sliding rod 12 (for example, in the X direction). In some examples, as shown in FIG. 32, the sealing ring 15 may be closer to the inside of the watch case 101 than the elastic member 3. The hole 1011 for the sliding rod 12 to slide is in gap fit with the sliding rod 12. The elastic member 3 is located in the gap between the sliding rod 12 and the hole 1011.

In this example of this disclosure, there may be one or more sealing rings 15. For example, in FIG. 32, two sealing rings 15 are included, and the two sealing rings are arranged in the X direction.

Still refer to FIG. 31 and FIG. 32. A gasket 16 may be disposed between the sealing ring 15 and the elastic member 3. In this way, one end of the elastic member 3 may press against the gasket 16, and the other end of the elastic member 3 may press against the pressure bearing plate 11.

Refer to FIG. 32. When the cap 13 is located at the third position and blocks the waterproof breathable member 2, under the external water pressure, the elastic member 3 is compressed and abuts against the gasket 16, and the gasket 16 that moves downward in the X direction also abuts against the sealing ring 15.

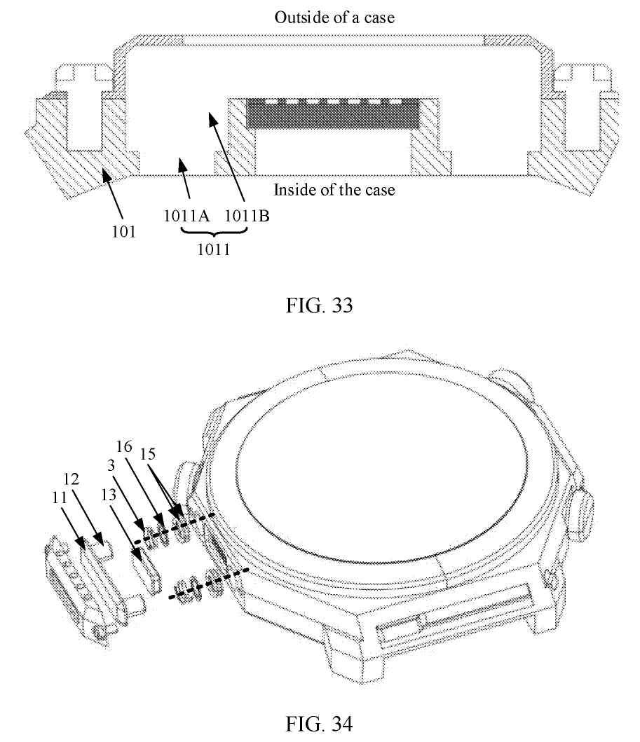

In some examples, as shown in FIG. 33, FIG. 33 is a diagram of a structure in which the blocking structure is removed. With reference to FIG. 31 and FIG. 32, in this example, the hole 1011 for the sliding rod 12 to slide includes a first segment 1011A and a second segment 1011B, an aperture of the first segment 1011A is smaller than an aperture of the second segment 1011B, and the first segment 1011A is closer to the inside of the watch case 101 than the second segment 1011B. In this way, a step is formed at a joint between the first segment 1011A and the second segment 1011B.

The elastic member 3, the gasket 16, and the sealing ring 15 may be located on the second segment 1011B, and the sealing ring 15 may press against the step.

As shown in FIG. 33, a part of the sliding rod 12 is disposed on the second segment 1011B with a larger aperture, so that the area of the cross section of the sliding rod 12 can be increased.

To increase the area of the cross section of the sliding rod 12, in some structures, an outer wall surface of the sliding rod 12 shown in FIG. 32 may be provided with a groove, and the sealing ring 15 and the gasket 16 are disposed in the groove, or the elastic member 3 may be disposed in the groove.

FIG. 34 shows an example of a disposing manner of the elastic member and the sealing ring. This example is similar to the example in FIG. 33. Both the sealing ring 15 and the elastic member 3 are sleeved outside the sliding rod 12. The sealing ring 15 and the elastic member 3 may be arranged in the extension direction of the sliding rod 12. The sealing ring 15 may be closer to the inside of the watch case 101 than the elastic member 3. The gasket 16 may be disposed between the sealing ring 15 and the elastic member 3.

In the example shown in FIG. 34, a plate-shaped cap 13 is used. In the example shown in FIG. 33, a ring-shaped cap is used. In some other examples, a cap including a plate-shaped structure and a ring structure may be alternatively used.

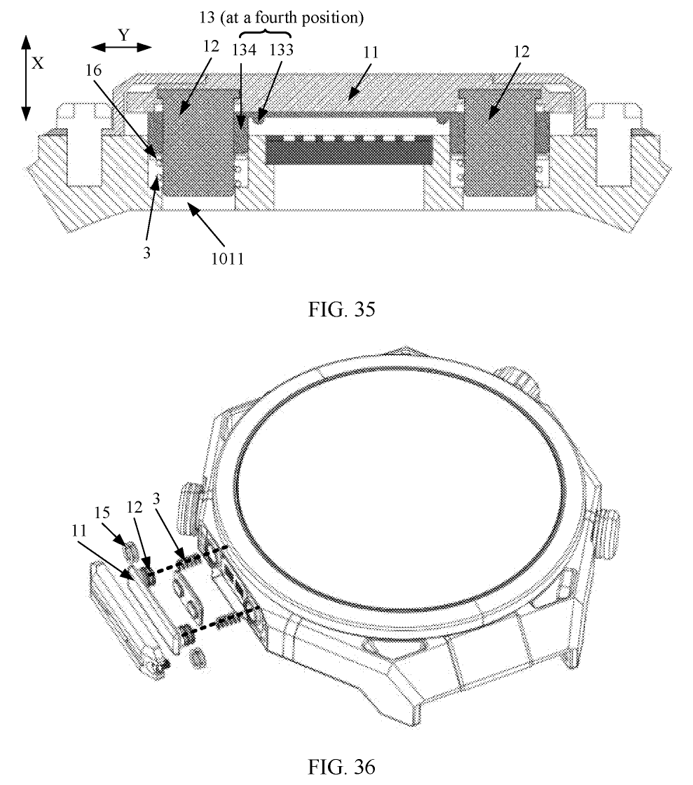

Refer to FIG. 35. FIG. 35 shows an example of another disposing manner of the elastic member and the sealing ring. In this example, the cap 13 includes a blocking part 133 and a sealing part 134. For example, the blocking part 133 and the sealing part 134 may be integrally formed.

The blocking part 133 is configured to block the waterproof breathable member 2, and the sealing part 134 is of a ring structure and extends into the gap between the sliding rod 12 and the hole 1011. In this way, the sealing ring does not need to be separately disposed, and a sealing effect can be achieved through the sealing part 134. In addition, an assembly process can be simplified.

In this example, when the blocking part 133 of the cap 13 does not block the waterproof breathable member 2, the sealing part 134 is located in the gap between the sliding rod 12 and the hole 1011. When the pressure bearing plate 11, the sliding rod 12, and the cap 13 move toward the waterproof breathable member 2 under the action of the water pressure, the sealing part 134 moves downward along the hole 1011 until the blocking part 133 blocks the waterproof breathable member 2. In the example shown in FIG. 35, the blocking part 133 is of a ring structure. In some other examples, the blocking part 133 may be of a plate-shaped structure. Alternatively, the blocking part 133 may further include a plate-shaped part and a ring-shaped part that are connected. Still refer to FIG. 35. The elastic member 3 may be sleeved outside the sliding rod 12, and the elastic member 3 is closer to the inside of the watch case. The gasket 16 may be disposed between the elastic member 3 and the sealing part 134, one end of the elastic member 3 abuts against the gasket 16, and the other end of the elastic member 3 abuts against the watch case 101.

It may be understood that, as shown in FIG. 35, when the cap 13 is at the fourth position and does not block the waterproof breathable member 2, the sealing part 134 extends into the gap between the sliding rod 12 and the hole 1011, to perform a sealing function.

For another example, when the cap 13 is at the third position and blocks the waterproof breathable member 2, the blocking part 133 blocks the waterproof breathable member 2, and the sealing part 134 moves downward in the X direction to press against the gasket 16.

In some examples, when the cap 13 is at the third position and blocks the waterproof breathable member 2, as shown in FIG. 35, the blocking part 133 may be attached to the watch case on the periphery of the waterproof breathable member 2. In some other examples, when the cap 13 is at the third position and blocks the waterproof breathable member 2, the blocking part 133 may be attached to the peripheral area of the waterproof breathable member 2. In this way, the size of the part that is of watch case and that bears the waterproof breathable member 2 in the Y direction can be compressed, and the area of the cross section of the sliding rod 12 can be increased.

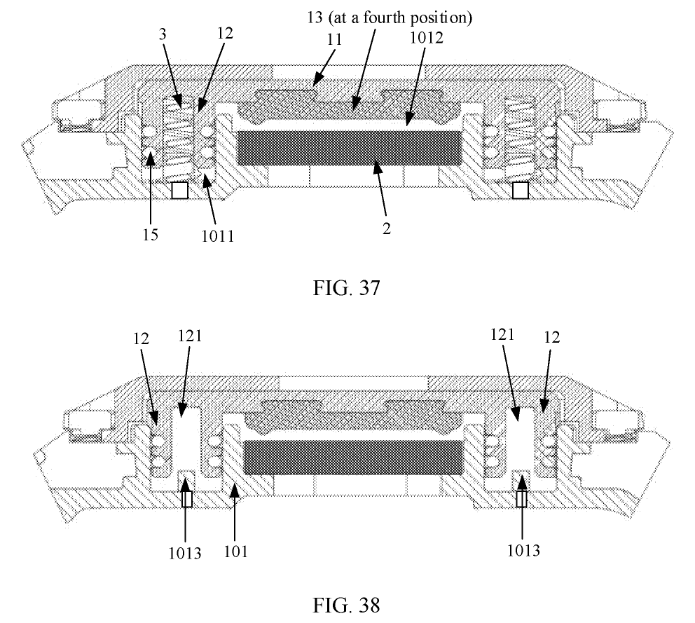

Refer to FIG. 36, FIG. 37, and FIG. 38. FIG. 36 and FIG. 37 show another disposing manner of the elastic member and the sealing ring. FIG. 38 is a diagram of a structure in which the elastic member is removed. In this example, the sliding rod 12 is provided with insert space 121, the elastic member 3 is located in the insert space 121, one end of the elastic member 3 may press against the sliding rod 12, and the other end of the elastic member 3 may press against the watch case 101.

In this example, the sealing ring 15 is sleeved outside the sliding rod 12.

It may be understood that, in this example, the elastic member 3 and the sealing ring 15 are not stacked in the extension direction of the sliding rod 12, but the sealing ring 15 is disposed outside the sliding rod 12, and the elastic member 3 is embedded inside the sliding rod 12. For example, when the elastic member 3 is the spring shown in FIG. 37, a quantity of circles of the spring may be increased. After the sliding rod 12 slides relative to the watch case 101 a plurality of times, a probability of failure of the elastic member is decreased, and use stability of the elastic member is improved.

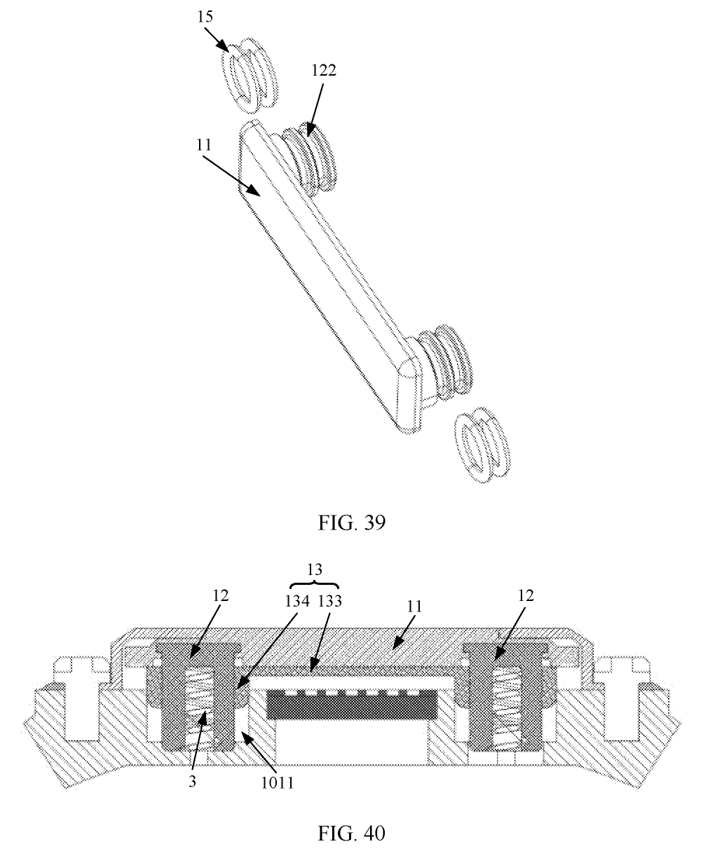

Refer to FIG. 39. The outer wall surface of the sliding rod 12 may be provided with a mounting slot 122, and the sealing ring 15 is disposed in the mounting slot 122. For example, when there are a plurality of sealing rings 15, a plurality of mounting slots 122 may be provided, the plurality of mounting slots 122 may be arranged in the extension direction of the sliding rod 12, and one sealing ring 15 is disposed in one mounting slot 122. In this way, when the sliding rod 12 slides along the watch case 101, distortion caused by interference between the plurality of sealing rings 15 is avoided. Therefore, in this disclosure, use reliability of the sealing ring can be improved. In addition, the area of the cross section of the sliding rod 12 may be further increased.

In the example in FIG. 37, the cap 13 includes a plate-shaped part and a ring-shaped part, to improve elasticity of the entire cap 13, so as to improve use reliability of the cap 13. In some other examples, the cap 13 in FIG. 37 may alternatively include only a plate-shaped part, or include only a ring-shaped part.

In some examples, the cap in FIG. 37 may be the cap structure shown in FIG. 35. The cap 13 includes a blocking part 133 and a sealing part 134. The blocking part 133 is configured to block the waterproof breathable member 2, and the sealing part 134 is of a ring structure and extends into the gap between the sliding rod 12 and the hole 1011. In this way, the sealing ring 15 in FIG. 37 may be omitted, and an assembly process of the device is simplified.

In FIG. 37, the cap 13 includes a blocking part 133 and a sealing part 134. The blocking part 133 may include a plate-shaped part and a ring-shaped part, to improve elasticity of the entire cap 13.

In the example in FIG. 37, the waterproof breathable member 2 is disposed in the groove 1012.

When the cap 13 is at the third position and blocks the waterproof breathable member 2, a part of the cap 13 extends into the groove 1012 and is press-fitted to the waterproof breathable member 2. As shown in FIG. 37, when the cap 13 is at the fourth position and does not block the waterproof breathable member 2, there is a gap between the cap 13 and the waterproof breathable member 2.

In some examples, when the cap 13 is at the fourth position and does not block the waterproof breathable member 2, the cap 13 may be located outside the groove 1012, or may be partially located in the groove 1012. However, there is a gap between the cap 13 and the waterproof breathable member 2.

To improve use stability of the elastic member 3, as shown in FIG. 38, a guide post 1013 extending into the insert space 121 may be disposed on the watch case 101, and the elastic member 3 may be sleeved on the guide post 1013. In this way, when the sliding rod 12 slides relative to the watch case 101, the elastic member 3 may be deformed along a straight line.

Because the hole 1011 of the sliding rod 12 needs to communicate with the inside of the watch case, a hole with a small aperture may be provided near the guide post 1013, and the hole with the small aperture communicates with the hole 1011 of the sliding rod.

Refer to FIG. 40. FIG. 40 shows an example of another disposing manner of the elastic member and the sealing ring. In this example, the cap 13 includes a blocking part 133 and a sealing part 134.

The blocking part 133 is configured to block the waterproof breathable member 2 the sealing part 134 is of a ring structure and extends into the gap between the sliding rod 12 and the hole 1011. In this example, the blocking part 133 is of a plate-shaped structure.

In addition, the sliding rod 12 is provided with insert space 121, the elastic member 3 is located in the insert space 121, one end of the elastic member 3 may press against the sliding rod 12, and the other end of the elastic member 3 may press against the watch case 101.

In this example, not only the blocking structure for sealing the hole gap and the cap are formed into an integrated structure, but also the elastic member 3 is disposed inside the sliding rod. In this way, the quantity of circles of the spring can be increased, and after the sliding rod 12 slides relative to the watch case 101 a plurality of times, the probability of the failure of the elastic member can be decreased, use stability of the elastic member can be improved, and a structure of the entire device can be simplified.

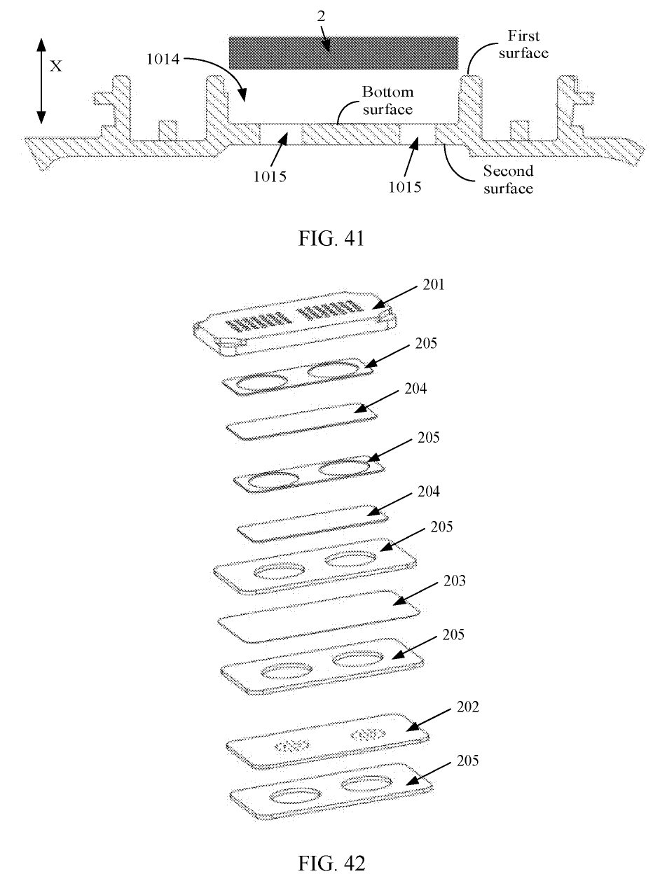

As shown in FIG. 41, FIG. 41 shows an example of a disposing manner of the waterproof breathable member 2. FIG. 41 is an exploded diagram of a structure of the waterproof breathable member 2.

In this example, it may be understood that the watch case 101 has a first surface and a second surface that are opposite to each other, the first surface faces the blocking structure, the first surface is provided with a groove 1014 that is recessed toward the second surface, there is a spacing between a bottom surface of the groove 1014 and the second surface, and the waterproof breathable member 2 is disposed in the groove 1014. In this way, when the blocking structure tightly presses the waterproof breathable member 2, a bottom surface of the waterproof breathable member 2 is pressed on the bottom surface of the groove 1014, and a risk of deformation and falling off of the waterproof breathable member 2 is decreased.

In some examples, as shown in FIG. 41, the first surface and the second surface of the watch case 101 are arranged in the X direction, and the second surface is closer to the inside of the wearable device than the first surface. When the blocking structure 1 is at the first position and blocks the waterproof breathable member 2, or the cap 13 moves to the third position and blocks the waterproof breathable member 2, an acting force applied by the cap 13 to the waterproof breathable member 2 enables the bottom surface of the waterproof breathable member 2 be press-fitted to the bottom surface of the groove 1014, to improve an attachment force between the waterproof breathable member 2 and the bottom surface of the groove 1014.

To connect the waterproof breathable member 2 to the internal space of the watch case 101, as shown in FIG. 41, a communicating hole 1015 is provided between the bottom surface of the groove 1014 and the second surface, and the waterproof breathable member 2 communicates with the internal space of the watch case through the communicating hole 1015.

The waterproof breathable member 2 in the example of this disclosure has a plurality of implementation structures. For example, as shown in FIG. 42, the waterproof breathable member 2 may include a first support plate 201, a second support plate 202, a waterproof breathable film 203, and a dust filter 204, and the first support plate 201 and the second support plate 202 each are provided with a breathable hole. The waterproof breathable film 203 and the dust filter 204 are stacked between the first support plate 201 and the second support plate 202.

In some structures, as shown in FIG. 42, two adjacent layer structures may be bonded together through a bonding layer 205. For example, the first support plate 201 is connected to the dust filter 204 through the bonding layer 205.

In this example, the dust filter 204 may be disposed to filter out external dust, to prevent external dust from entering the wearable device.

The first support plate 201 and the second support plate 202 may be disposed to improve mechanical strength of the entire waterproof breathable member 2, and improve use reliability of the module.

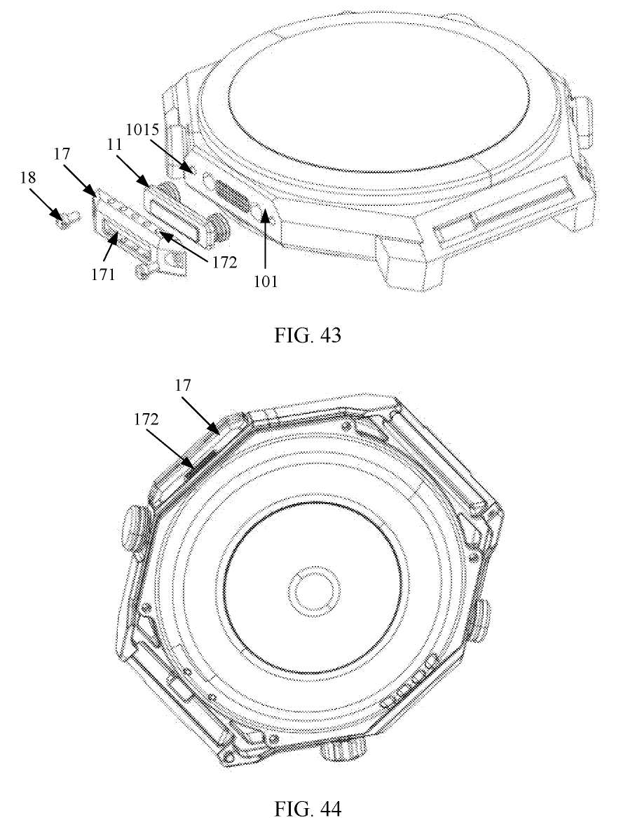

In the wearable device provided in this embodiment of this disclosure, as shown in FIG. 43 and FIG. 44, the device may further include a decorative plate 17. The decorative plate 17 is provided with a mounting cavity 171, and at least a part of the blocking structure 1 is slidably disposed in the mounting cavity 171.

In some implementable structures, as shown in FIG. 43, the decorative plate 17 may be fastened to the watch case 101 through a connector 18 (for example, a bolt). For example, when the connector 18 is a threaded connector, the watch case 101 may be provided with a mounting hole 1015 for the threaded connector to extend.

For communicating between the inside and the outside of the wearable device, for example, a sound spread by a speaker needs to be propagated to the outside of the wearable device, for another example, a pressure difference between the inside and the outside of the wearable device needs to be maintained, or for another example, water inside the wearable device needs to be discharged, as shown in FIG. 43, the decorative plate 17 is provided with a through hole 172 for communicating with the internal space of the watch case.

To prevent dust from entering the watch case through the through hole 172, a filter structure may be disposed at the through hole 172. For example, a filter screen may be disposed.

In some examples, the through hole 172 may be provided on one surface of the decorative plate 17, or may be provided on a plurality of surfaces. As shown in FIG. 44, a surface on which the through hole 172 is provided may be a surface facing an arm of the user, or may be a surface away from an arm of the user.

In an assembly process, the waterproof breathable member 2 may be first mounted on the watch case. Then, the blocking structure is mounted on the watch case, where the sliding rod of the blocking structure is inserted into the hole of the watch case. Then, the decorative plate is mounted, that is, the decorative plate is fastened to the watch case through the connector.

In the foregoing examples, the waterproof breathable member 2 may be fastened to the watch case, and the blocking structure 1 is slidably disposed on the watch case.

In some other examples, the waterproof breathable member 2, the blocking structure 1, and the elastic member 3 may be all disposed on a support member. For example, the waterproof breathable member 2 is fastened to the support member, and the blocking structure 1 is slidably disposed on the support member. For a position relationship and a connection relationship between the waterproof breathable member 2, the blocking structure 1, and the elastic member 3, refer to the foregoing examples.

The support member may be disposed on a main body of the electronic device through a connector. For example, the electronic device may be a wearable device, or may be glasses. The main body may be a watch case of the wearable device, or may be a frame or a temple of glasses.

The support member is configured to enclose a hole for communicating with the inside of the main body of the electronic device. In an example, the support member may be provided with a hole. Alternatively, a plurality of support members enclose a hole, or the support member and the main body of the electronic device enclose a hole.

The support member for disposing the blocking structure 1 and the support member for disposing the waterproof breathable member 2 may be different support members, or may be the same support member.

The support member may be detachably connected to the main body of the electronic device through the connector. For example, the main body may be provided with a mounting cavity for mounting the support member, and a structure including the support member, the waterproof breathable member, and the blocking structure is disposed in the mounting cavity of the watch case through connectors.

In a scenario, a waterproof breathable member may also be disposed on the watch case. For example, when the wearable device does not dive, the waterproof breathable member disposed on the watch case is used for breathability, drainage, and the like. When the wearable device dives, the structure including the support member, the waterproof breathable member, and the blocking structure may be disposed in the mounting cavity of the watch case.

In the descriptions of this specification, the described specific features, structures, materials, or characteristics may be combined in a proper manner in any one or more of embodiments or examples.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A wearable device comprising:
a watch body comprising:
an inside;
a watch case enclosing the inside and comprising a first hole communicating with the inside;
a waterproof breathable member communicating with the inside; and
a blocking structure disposed on the watch case, comprising a first side facing the inside and disposing the waterproof breathable member, and configured to move based on water pressure, toward the waterproof breathable member along the first hole to block the waterproof breathable member.

2. The wearable device of claim 1, wherein the watch body further comprises an elastic member configured to apply an elastic force to move the blocking structure in a first direction away from the waterproof breathable member, and wherein the blocking structure is further configured to move, based on the elastic force, away from the waterproof breathable member along the hole to form a gap between the blocking structure and the waterproof breathable member.

3. The wearable device of claim 2, wherein the blocking structure further comprises:
a pressure bearing plate comprising a second side that faces the waterproof breathable member;
at least one sliding rod coupled to the pressure bearing plate disposed in the hole, and configured to move along the hole; and
a cap comprising an elastic material, coupled to the pressure bearing plate, located on the second side, and configured to block the waterproof breathable member.

4. The wearable device of claim 3, wherein the cap comprises a plate-shaped part configured to block the waterproof breathable member.

5. The wearable device of claim 3, wherein the cap comprises a third side that faces the waterproof breathable member, wherein the third side comprises a protrusion forming a closed ring structure and protruding in a second direction toward the waterproof breathable member, and wherein the closed ring structure is disposed around the waterproof breathable member when the cap blocks the waterproof breathable member.

6. The wearable device of claim 5, wherein the cap further comprises a plate-shaped part, wherein the closed ring structure surrounds the plate-shaped part, and wherein the plate-shaped part and the closed ring structure are configured to block the waterproof breathable member.

7. The wearable device of claim 5, wherein the cap comprises a ring structure, and wherein the pressure bearing plate and the ring structure are configured to block the waterproof breathable member.

8. The wearable device of claim 3, wherein the at least one sliding rod comprises a plurality of sliding rods spaced apart from each other on the pressure bearing plate, and wherein the cap is disposed around the plurality of sliding rods or located between the plurality of sliding rods.

9. The wearable device of claim 8, wherein the cap further comprises a third side that faces the waterproof breathable member, wherein the third side comprises a closed ring structure protruding in a second direction toward the waterproof breathable member to form a protrusion, and wherein the waterproof breathable member comprises:
a breathable area comprising a plurality of breathable holes communicating with the inside; and
a peripheral area disposed around the breathable area and configured to couple the protrusion when the cap blocks the waterproof breathable member.

10. The wearable device of claim 3, wherein the at least one sliding rod comprises an insert space, and wherein the elastic member is located in the insert space.

11. The wearable device of claim 10, wherein the elastic member comprises:
a first end that contacts the at least one sliding rod; and
a second end that contacts the watch case.

12. The wearable device of claim 10, further comprising a guide post disposed on the watch case and extending into the insert space, wherein the elastic member is sleeved on the guide post.

13. The wearable device of claim 10, wherein the watch body further comprises a sealing ring sleeved on the at least one sliding rod.

14. The wearable device of claim 13, wherein each of the at least one sliding rod comprises an outer wall surface comprising a mounting slot, and wherein the sealing ring is disposed in the mounting slot.

15. The wearable device of claim 3, wherein the elastic member is sleeved on the at least one sliding rod.

16. The wearable device of claim 15, wherein the watch body further comprises a sealing ring sleeved on the at least one sliding rod, and wherein the elastic member and the sealing ring are arranged in an extension direction of the at least one sliding rod.

17. The wearable device of claim 3, wherein the cap comprises:
a blocking part configured to move toward the waterproof breathable member along the hole to block the waterproof breathable member; and
a sealing part coupled to the blocking part and located in a gap between the at least one sliding rod and the hole.

18. The wearable device of claim 17, wherein the blocking part and the sealing part are an integrally formed mechanical member.

19. The wearable device of claim 17, wherein the at least one sliding rod comprises an insert space, and wherein the elastic member is disposed in the insert space.

20. The wearable device of claim 1, wherein the watch case further comprises:
a first surface facing the blocking structure and comprising a groove, wherein the waterproof breathable member is disposed in the groove, and wherein the groove comprises a bottom surface;
a second surface located opposite to the first surface, wherein the groove is recessed toward the second surface; and
a second hole disposed between the bottom surface and the second surface and between the waterproof breathable member and the inside, and
wherein the watch body further comprises a decorative plate comprising:
a mounting cavity, wherein a part of the blocking structure is slidably disposed in the mounting cavity;
a through hole communicating with the inside; and
a filter structure disposed at the through hole.
